(19) United States
(12) Patent Application Publication
(10) Pub. No.: US 2009/0210444 A1
(43) Pub. Date: Aug. 20, 2009

(54) SYSTEM AND METHOD FOR COLLECTING BONAFIDE REVIEWS OF RATABLE OBJECTS

(76) Inventors: Christopher T.M. BAILEY, Atlanta, GA (US); Michael J. ROWAN, Wakefield, RI (US); Kefeng CHEN, Duluth, GA (US); Neal Lewis CREIGHTON, JR., Needham, MA (US)

Correspondence Address: WILMERHALE/BOSTON, 60 STATE STREET, BOSTON, MA, 02109, US

(21) Appl. No.: 12/253,493

(22) Filed: Oct. 17, 2008

Related U.S. Application Data
(60) Provisional application No. 60/980,687, filed on Oct. 17, 2007.

(51) Int. Cl. G06F 17/30

(52) U.S. Cl. 707/103 R; 707/E17.055; 709/206

(57) ABSTRACT

A method for providing a computer-based service to automatically evaluate and determine authenticity of a rating. The computer system receives (a) input with rating information that includes a rating and identification data for a specified ratable object and (b) rater profile information including identification information and usage information associated with a user of the computer based service. At least one evaluation step is performed to determine a risk level associated with the rating information, the rater profile information, and an associated time frame. Based on the risk level, an evaluation outcome message is communicated to the user. The evaluation outcome message may include an acceptance message, an information request message, and a rejection message. With the acceptance message, the service accepts the rating for storage in a rating information database. With the information request message, the service implements a verification process. With the rejection message, the service rejects the rating.

### CROSS REFERENCE TO RELATED APPLICATIONS

This application claims priority under § 119 to U.S. Provisional Patent Application No. 60/980,687 filed Oct. 17, 2007, the entire contents of which are herein incorporated by reference.

This application is also related to the following co-pending applications, the entire contents of which are herein incorporated by reference: U.S. patent application Ser. No. 11/639,679, filed on Dec. 15, 2006, entitled SYSTEM AND METHOD FOR PARTICIPATION IN A CROSS PLATFORM AND CROSS COMPUTERIZED-ECO-SYSTEM RATING SER VICE; U.S. patent application Ser. No. 11/639,678, filed on Dec. 15, 2006, entitled SYSTEM AND METHOD FOR DETERMINING BEHAVIORAL SIMILARITY BETWEEN USERS AND USER DA TA TO IDENTIFY GROUPS TO SHARE USER IMPRESSIONS OF RATABLE OBJECTS; and U.S. patent application Ser. No. 11/711,223, filed on Feb. 27, 2007 entitled SYSTEM AND METHOD FOR PARTICIPATION IN A CROSS PLAT FORMAND CROSS COMPUTERIZED-ECO-SYSTEM RATING SERVICE; and U.S. patent application Ser. No. 11/711,248, filed on Feb. 27, 2007 entitled SYSTEM AND METHOD FOR MULTIPLAYER COMPUTERIZED GAME ENVIRONMENT WITH NON-INTRUSIVE, CO-PRESENTED COMPUTERIZED RATINGS.

### BACKGROUND

1. Technical Field of the Invention

The present invention relates generally to electronic services that allow users to rate services and the like and to receive rating information about such services and the like and, more particularly, to a computerized system and method for collecting, authenticating and/or validating bonafide reviews of ratable objects.

2. Discussion of Related Art

The Internet and the World-Wide-Web are increasingly becoming a major source of information for many people. New information (good or bad) appears on the Internet constantly. In order to help people better determine the usefulness of this information, rating services exist to provide both rating and commenting information that may help people make better determinations about the quality or usefulness of brick and mortar organizations, products, services, Internet organizations, Internet Web Sites, and/or specific content within a web page.

The majority of these systems solicit the user's rating and opinions on a specific ratable object, such as a company, a product, a web site, an article or a web page. When a user is looking for rating information regarding an ratable object, either for online shopping or any other purpose, the system presents a rating for the object to the user that was created by a previous user or users. Most system and services that exist today provide these ratings and reviews in an anonymous and/or semi-anonymous way with minimal or no authentication to help determine if the rating and review are from a legitimate user. At the very least, these systems do not ask for or require collection and verification of any identifiable information to determine whether a review for a ratable object is either real or whether the review might be fraudulent.

Some systems ask the user to submit and verify their email address. Some systems may even check to see if their email address is unique to ensure that no user submits more than (1) one review per ratable object. Still, these techniques do very little to stop potential fraudulent activity or determine if the rater has the authority to rate the object. Once this information is collected for the ratable object, these ratings and reviews are presented as reviews that other users can use in order to make future transaction decisions about the object that is being rated which could be misleading if the data source has a vested interest to present false data about the object.

When these systems present a rating to a user, there is no consideration of the way the rating information was collected, who the rater might be or if they have a vested interest in rating a certain way. Since people rely on this information, greater prevention techniques are needed to ensure the users of these ratings and reviews can be trusted as reliable reviews from actual users with experience with the ratable object.

Some systems use vetting techniques of the reviewer like verifying that the user has access to an email address. For example, Yelp and Yahoo, ask reviewers of a business to verify their email address once and then a user name and password will be provided to the reviewer to log into the account for future reviews. Once this email verification is completed, the reviewers' ratings and reviews will be posted as a trusted review. The assumption is that the reviewer has actually had a transactional experience and/or is not a fraudulent reviewer of the site. Still, other systems such as Bazaarvoice, Inc. do not require authentication of the rater when a rater rates or reviews a product or service. Furthermore, none of these services today try to detect that these transactions might be fraudulent. There is a need for a reliable system to authenticate and verify raters and the ratings they submit to review a ratable object, in order to detect those transactions that may be fraudulent.

### SUMMARY

The present invention provides a system and method for generating bonafide ratings of ratable objects by identifying fraudulent activity and evaluating transactional relationships of raters/reviewers to ratable objects. The system and method provide trustworthy rating and review information to users relying on this information to determine if they should conduct future transactions with the ratable object in question. In a multi-stage vetting process, the system automatically evaluates a rater or reviewer's profile information, the rating submitted and data concerning the ratable object and produces a bonafide rating. Bonafide ratings may then be incorporated into a rating database, accessed by users interested in obtaining a trustworthy rating of a ratable object such as a company, person, website, product, service, virtual ratable object etc., or utilized for any variety of purposes.

Under one embodiment of the invention, a method, performed on a computer system, provides a computer-based service to automatically evaluate and determine authenticity of a rating. The method includes receiving input at the computer system with rating information, the rating information including a rating for a specified ratable object and identification data for the ratable object. The method includes receiving input at the computer system with rater profile information, the rater profile information including at least one of identification information and usage information associated with an active user of the computer based service. The method includes performing at least one evaluation step, the at least one evaluation step evaluating the received input at the computer system. Evaluating includes determining a risk level associated with the rating information, the rater profile information, and a time frame associated with receiving input. The method includes determining, based on the risk level, an evaluation outcome message. The system communicates to the active user the evaluation outcome message, the evaluation outcome message including at least one of an acceptance message, an information request message, and a rejection message. Upon communication of the acceptance message, the computer-based service accepts the rating for the specified ratable object for storage in a rating information database. Upon communication of the information request message, the computer-based service implements a verification process. Upon communication of the rejection message, the computer-based service rejects the rating for the specified ratable object for storage in the rating information database.

According to one aspect, the ratable object includes one of a business, a person, a product, a URI, a website, web page content, a virtual object, a virtual product, or a virtual service.

According to another aspect, receiving input at the computer system includes receiving electronic information by way of one of a URI, an Internet capable application, Javascript, SMS texting, Telephone, Flash object, and application program interface (API).

According to another aspect, communicating to the active user an evaluation outcome message includes transmitting electronic information by way of one of a URI, an Internet capable application, Javascript, SMS texting, Telephone, Flash object, and application program interface (API).

According to another aspect, the evaluation step includes classifying the rating as one of positive and negative.

According to another aspect, the evaluation step includes evaluating the rater profile information to determine whether the active user is an ad hoc user.

According to another aspect, the evaluation step includes evaluating the rater profile information to determine whether the active user is a recruited user.

According to another aspect, the evaluation step includes evaluating usage information to determine a usage history via at least one of tracking an IP address, applying a cookie and requesting usage information from the active user.

According to another aspect, evaluating a time frame associated with receiving input includes determining whether an upper or lower time limit for receiving input at the computer system with rating information is exceeded.

According to another aspect, evaluating the rating information includes determining whether an upper or lower text limit for rating information is exceeded.

According to another aspect, determining a risk level includes identifying a combination of rating information, the rater profile information, and time frame associated with receiving input as high risk.

According to another aspect, determining a risk level includes identifying a combination of rating information, the rater profile information, and time frame associated with receiving input as medium risk.

According to another aspect, determining a risk level includes identifying a combination of rating information, the rater profile information, and time frame associated with receiving input as low risk.

According to another aspect, the verification process includes automatically communicating to the active user via at least one of an SMS message, an e-mail message, a telephone call, a facsimile and a postal message, a request for additional information.

According to another aspect, the request for additional information includes one of active user confirmation, additional identification information and additional usage information associated with the active user.

According to another aspect, upon communication of the acceptance message, the method further includes assigning a transaction identity to the rating information, the transaction identity comprising the risk level, the evaluation outcome message, the rater profile information, and the time frame associated with receiving input.

According to another aspect, upon communication of the rejection message, the method further comprises assigning a transaction identity to the rejected rating information, the transaction identity comprising the risk level, the evaluation outcome message, the rater profile information, and the time frame associated with receiving the input.

### BRIEF DESCRIPTION OF THE DRAWINGS

In the drawings:

FIG. 1 illustrates a block diagram of a user rating system with the basic infrastructure for providing a bonafide rating and review service, according to one embodiment;

FIG. 2 illustrates an initial create rating and review web page, according to one embodiment;

FIG. 3 illustrates a threat matrix to identify rating/review fraud activity, according to one embodiment;

FIG. 4 illustrates a block diagram of a low risk authentication process flow experienced by a rater/reviewer using the system, according to one embodiment;

FIG. 5 illustrates an example of a web browser based positive rating/review ready to be submitted by the rater/reviewer, according to one embodiment;

FIG. 6 illustrates an example of an email that the rater/review may authenticate to continue the rating/review submission process, according to one embodiment;

FIG. 7 illustrates an example positive rating/review completion page or “Thank You” page indicating that the rating/review has been successfully submitted, according to one embodiment;

FIG. 8 illustrates a block diagram of a medium risk negative rating/review process flow experienced by a rater/reviewer using the system, according to one embodiment;

FIG. 9 illustrates an example of a web browser based negative rating/review ready to be submitted by the rater/reviewer, according to one embodiment;

FIG. 10 illustrates an example of a webpage that is returned to the rater/reviewer's web browser requesting user agreement prior to continuing the rating/review submission process, according to one embodiment;

FIG. 11 illustrates an example of a webpage that is returned to the rater/reviewer's requesting email confirmation, according to one embodiment;

FIG. 12 illustrates an example of an email that the rater/review may authenticate to continue the rating/review submission process, according to one embodiment;

FIG. 13 illustrates an example of a webpage that the rater/reviewer may utilize to receive a real time automated verification phone call, according to one embodiment;

FIG. 14 illustrates an example of a webpage that the rater/reviewer may utilize to continue the rating/review process, according to one embodiment;

FIG. 15 illustrates an example of a webpage that the rater/reviewer may utilize to provide additional details about the negative rating/review, according to one embodiment;

FIG. 16 illustrates an example negative rating/review completion page or “Thank You” page indicating that the rating/review has been successfully submitted, according to one embodiment;

FIG. 17 illustrates a block diagram of a medium risk for a positive rating/review authentication process flow experienced by a rater/reviewer using the system, according to one embodiment;

FIG. 18 illustrates an example of a webpage that requesting rater/reviewer's agreement prior to continuing the rating/review submission process, according to one embodiment;

FIG. 19 illustrates a block diagram of a high risk for a positive rating/review process flow experienced by a rater/reviewer using the system, according to one embodiment;

FIG. 20 illustrates an example of a webpage that is returned to the rater/reviewer's web browser that block the rater/reviewer from continuing the rating/review submission process, according to one embodiment;

FIG. 21 illustrates a block diagram of the complete authentication process flow as indicated in FIG. 4, FIG. 8, FIG. 17 and FIG. 18, according to one embodiment;

FIG. 22 illustrates example algorithms used in the high risk fraud checks to determine high risk fraud activity, according to one embodiment;

FIG. 23 illustrates example algorithms used in the medium risk fraud checks to determine medium risk fraud activity, according to one embodiment;

FIG. 24 illustrates an example of the system's configurable fraud detection variables that can be set to change the sensitivity of the systems fraud detection, according to one embodiment;

FIG. 25 illustrates a block diagram of the system's Telephony rating/review collection process flow, according to one embodiment;

FIG. 26 illustrates a block diagram of the system's SMS (short messaging service) rating/review collection process flow, according to one embodiment;

FIG. 27 illustrates a block diagram of the high level infrastructure and system elements to create a rating/review collection platform, according to one embodiment;

FIG. 28 illustrates an example of the system's initial response to a rater/reviewer if the rater/reviewer is submitting a rating/review for the same ratable object, according to one embodiment;

FIG. 29 illustrates an example of a webpage that is returned to the rater/reviewer's when an email verification process is implemented, according to one embodiment, and

FIG. 30 illustrates an example of a webpage that is returned to the rater/reviewer's that asks the rater/reviewer if they would like to overwrite the previous review, according to one embodiment.

FIG. 31 is a diagram that depicts the various components of a computerized system for generating bonafide ratings, according to certain embodiments of the invention.

### DETAILED DESCRIPTION

A mechanism is provided to automatically identify bonafide raters and reviewers of ratable objects like a company, a product, a person, a URI, a web site, a web page content, a virtual object, virtual products, or virtual service so that rating information may be trusted from and shared with other users of the system. Data is relayed via multiple protocols like a http (web browser), SMS (texting), Telephone (phone lines) and other standard and proprietary methods and protocols like Skype and public and/or private instant messaging systems. A computerized system generates bonafide ratings by executing various computer implemented algorithms to evaluate the relationship between the rater/reviewer and the ratable object, using various characteristics of the rating itself to trigger each evaluation process.

The computerized systems provides fraud prevention for computerized reviews/ratings and generates legitimate, trustworthy, and/or bonafide ratings/reviews by identifying biased rating/reviews. The method seeks to isolate fraudulent reviews by a series of mechanisms, one of which includes the identification of vested interests. The method is based, at least in part, on the fundamental idea that vested interests may encourage users of a rating system to produce biased reviews. Thus in certain circumstances, a rater/reviewer may submit an inaccurately positive rating/review of a ratable object when that rater/reviewer seeks to benefit from a positive rating/review. By way of an introductory example, an owner of a business or service might be inclined to submit a positive review of his or her business or service to help generate an inflated, good reputation. Conversely, in certain circumstances, a rater/reviewer may submit an inaccurately negative rating/review of a ratable object when that rater/reviewer seeks to benefit from a negative rating/review. By way of example, an owner of a business or service might be inclined to submit a negative review of his or her competitor's business or service to help generate a deflated, bad reputation for that competitor, thereby improving the relative appeal of his or her own business or service.

The computerized system for generating bonafide ratings goes about identifying potentially biased reviews by executing a series of authentication and verification processes. The processes are structured to identify the fraud risk level associated with the rating/review. Those processes aimed at identifying at least some likelihood of vested interest include the execution of algorithms that compare data for the ratable object to data for the rater/reviewer. Those processes aimed at identifying different manifestations of fraud may examine time frames associated with generating and submitting ratings, origins of the rater/reviewer's use of the rating system, and a variety of other parameters. The computerized system may combine any variety of these processes and employ communication mechanisms to request confirmation steps, additional information from raters/reviewers, etc. In sum, a multi-step, multi-dimensional process is implemented to identify and minimize fraudulent ratings, while creating a legitimacy measure for those ratings that successfully pass the authentication and verification process. The multi-step, multi-dimensional rating/review process is described in detail below.

A reviewer typically undergos various authentication levels of vetting in order to submit a review. The authentication process may request only a minimal amount of data from the rater/reviewer. Alternately, multiple types of data may be requested from the rater/review and a more extensive authentication process executed. In each case, the rater/review provides data which is then verified, based on pre-determined system triggers. Certain data inputs may initiate a process which requests additional information about the rater/reviewer that may be provided and verified. Each such variation is discussed more fully in the sections that follow.

Under certain embodiments, a reviewer's activity is monitored and analyzed via a series of detection algorithms. The detection algorithms are constructed to meet a variety of application parameters. The detection algorithms are used to determine if a rater/reviewer might have a vested interest to provide either a positive rating/review or a negative rating/review.

The system and method for determining bonafide ratings and review relies on the system's applied levels of authentication for the rater/reviewer and when to apply each authentication level based on the various fraudulent threats of misrepresenting the rating and review content. The system relies on the user's rating/review submission behavior to identify how and when the system applies the authentication methods in order to successfully submit a rating or review for a ratable object. This determination is key, in so far as vested interests are understood to bias rating outcomes either towards inaccurately negative or inaccurately positive outcomes.

The service authenticates or validates bonafide reviewers of ratable objects (organizations, products, services, websites, and other objects). In order to authenticate a reviewer, the service collects different elements of information for a particular reviewer. Where most rating services would simply collect basic information from a reviewer such as email address, the described embodiment goes further, and continues to monitor the reviewer information. At the outset, the service collects the standard information, such as the reviewer's email address. But in certain cases where the reviewing/rating warrants more checks, the service performs additional checks as placing an automated telephone call to the reviewer, recording the information received to provide an additional contact point beyond what is already on file. In addition, at any point, and this could be randomly selected, the user could be taken through an extended authentication process where the reviewing/rating service performs additional authentication steps to validate the authenticity of the review information. For example, an automated telephone call could be placed to a new or predetermined phone number of the reviewer. Or, an addition email message, SMS, or other mechanism could be used and may be accepted and confirmed by the reviewer.

In order to authenticate and validate a review, a risk evaluation system is employed. The risk evaluation system is designed to differentiate ratings that are likely potential fraudulent activity from those which are not likely to comprise fraudulent activity. Under one embodiment, fraudulent rating/reviews are measured in a 6 category framework system, in which 4 categories represent potential fraudulent activity. The 6 categories are defined as either positive or negative rating/reviews coming from a user like a customer, a party with a vested interest in the ratable object's success like an owner, or a party with a vested interest in the ratable object's failure like a competitor. This 6-category system helps to show that 4 of the 6 categories are likely potential fraudulent activity. The first category is one in which a ratable object owner could be submitting a review for his or her own ratable object. Because the ratable object owner likely has a vested interest in submitting a positive rating or review for their company, product, etc. and because future users of these rating and reviews may depend on this information to determine whether a transaction should occur with the ratable object, the system will flag this positive rating/review. The system will then stop the rating/review, or have the rating/review undergo more a intense vetting process. The second, third, and fourth categories are those in which a competitor or agent of the ratable object could be submitting a review of the ratable object. Because the competitor of the ratable object has an vested interest in submitting a negative review for the company, product, etc. and future users of these ratings/reviews may depend on this information to be objective to determine if a transaction should occur with the ratable object, RatePoint will flag this transaction to stop the rating/review, or have the rating system undergo more intense vetting of the rating/review.

The rating system may differentiate ratings that are likely potential fraudulent activity from those which are not likely to comprise fraudulent activity by classifying the rating/review under a risk standard. The system will look for fraudulent activity and classify each rating/review transaction as having a low risk, a medium risk, or a high risk of fraudulent activity. If the transaction has a low risk of be fraudulent activity, the system will vet the reviewer with a minimum set of standards. If the transaction has a medium risk of being fraudulent, then the system will vet the reviewer with the minimum set of standards, plus an additional set of standards that include an out of band verification checks that creates a two factor authentication check. If the transaction has a high risk of being fraudulent, then the system will simply block the transaction from entering our system and notify the reviewer of the situation.

The collection of reviews and ratings is accomplished via multiple processes. The processes may be performed via the web and a browser using a standard web form, sending an SMS message to the service, via a telephone call placed either by the reviewer or automatically by the reviewing/rating service to the user, via email, fax message, postal mail or other means. All the collected reviews/ratings are stored and made available to the participating businesses via a centralized ASP environment. In addition, the reviewing/rating system collects reviews and ratings relating to the participating businesses from other available resources and brings those into the ASP service, thereby making the ASP service a central location for all review, rating, and reputation information for a member company.

Various parameters are used to determine whether a review/rating should be further scrutinized to determine its validity. If, for example, the reviewer submits a negative review, there is a higher chance that the reviewer might be a competitor or a competitor's agent. In such a case, the reviewer shall be placed in a process that warrants additional vetting. If the reviewer submits a review with the same email address as an existing rating for a ratable object that is stored by the system, then the reviewer shall be allowed to replace the previous rating/review. The user will be blocked from adding an additional review. This analysis is adapted to limit an individual reviewer from independently biasing a collective rating of a ratable object. A similar process may be enacted via telephone or SMS. Under another aspect, if the reviewer submits a review with the same telephone or SMS number and proves access to this telephone or SMS number, then the reviewer shall be allowed to replace the previous rating/review.

Yet other criteria are used to refine the rating system. In one embodiment, if the reviewer creates and submits a review in under a pre-determined amount of time and/or the time period to write a review is greater than a pre-defined word per minute rate, then the review shall be placed in a process that warrants additional vetting. Under another embodiment, if the reviewer submits a review that is to long or to short as defined by the system, then the reviewer shall be placed in a process that warrants additional vetting. Under another aspect, if the organization receives more reviews per visitor to the site than the system allows, then the review shall be placed in a process that warrants additional vetting. In certain instances, a ratable object's first set of reviews for a ratable object within a pre-determined timeframe are flagged for additional vetting.

The system employs various methods to track the manner in which a rating or review is collected. Various steps are taken to ensure a quality collection process. If, for example, the reviews are collected in ad hoc and free-formed manner, as opposed to through some of the automated tools that the system provides, then the system will flag the reviews as suspect. Examples of automated tools provided by the system include email requests for reviews sent out to the organization's customer base. In certain embodiments, the system tracks the IP address of the organization used when it signed up for an account with the system. By analyzing all the future ratings and reviews of the rater's IP with Organization's signup the system can try to determine if an Organization is trying to review itself or it products, services, etc. the system can stop the submission and inclusion of the rater's rating or review because it is likely not objective, as the source of the rater is highly likely to be the organization which is likely to have a vested interest in submitting a basis positive review for the rated object.

Unique identifiers may also be used to improve the robustness of the vetting process. In certain embodiments, the system applies a cookie (a unique code applied by the system to determine identity, setting, and preference data for future return visits to the system) to the web browser of the organization when it previously signed up for an account with the system and another cookie when it actually administers their account on the system. By analyzing all the future ratings and reviews while looking for this same cookie on the rater's web browser, the system can selectively stop the submission and inclusion of the rater's rating or review. This feature is employed when the reviewer is evaluated to be likely to have a vested interest in a particular rating—e.g. the source of the rater is highly likely to be the organization which is likely to have a vested interest in submitting a biased positive review for the rated object. The system may then transfer the reviewer to undergo further authentication because the review is deemed likely not objective.

Each feature may be selected and employed to better provide a mechanism of automatically identifying bonafide raters and reviewers of ratable objects towards the eventual goal of delivering trustworthy ratings and reviews. Ratable object, as used herein, include but are not limited to a company, a product, a person, a URI, a web site, a web page content, a virtual object, virtual products, and/or virtual service. In the exemplary system, company rating/reviews are used. For purposes of illustration, the sections that follow discuss a system and authentication method for generating bonafide user ratings on businesses. The ensuing discussion should not be considered limiting, as the system and methods will also apply to any other ratable objects and entities.

A user can submit a particular rating on an entity through an application or an element and/or entity within or accessible via a URI and/or application either through an Internet capable application like a web browser (via a toolbar, web page or web portal), Javascript, SMS texting, Telephonic, Flash object, application programming interface (API) or any other protocol or method that can call and display content over a network and/or the Internet. A user can be a registered user to the system or be an anonymous user, i.e., the system does not have the user's identification information. Rating information may be trusted from and shared with other users of the system by way of multiple protocols including but not limited to a http (web browser), SMS (texting), Telephone (phone lines) and other standard and proprietary methods and protocols like Skype and public and/or private instant messaging systems.

A variety of levels of authentication and verification of the reviewer/rater may be used. In the aforementioned embodiments, a reviewer is requested to undergo various authentication levels or levels of vetting in order to submit a review. The authentication process may request only a minimal amount of data from the rater/reviewer that should be provided and verified and based on system triggers. Or, the process may request additional information about the rater/reviewer that should be provided and verified as discussed more fully in the sections that follow.

Under certain embodiments, a reviewer's activity is monitored and analyzed via a series of detection algorithms used to determine if a rater/reviewer might have a vested interest to provide either a positive rating/review or a negative rating/review.

The system and method for determining bonafide ratings and review relies on the system's applied levels of authentication for the rater/reviewer and when to apply each authentication level based on the various fraudulent threats of misrepresenting the rating and review content. The system relies on the user's rating/review submission behavior to identify how and when the system applies the authentication methods in order to successfully submit a rating or review for a ratable object.

In various embodiments, the disclosed system and method determines how and when each authentication method is used to render bonafide user ratings on businesses. These authentication methods are discussed more fully in the sections that follow. The system can be applied to an entity as a company, a person, a product, a URI, a web site, web page content, a virtual object, virtual products, or virtual services. In one exemplary system, company rating/reviews are used. In various embodiments, a user can submit a particular rating on an entity through an application or an element and/or entity within or accessible via a URI and/or application either through an Internet capable application like a web browser (via a toolbar, web page or web portal), Javascript, SMS texting, Telephonic, Flash object, application programming interface (API) or any other method that can call and display content over a network and/or the Internet. A user can be a registered user to the system or be an anonymous user, i.e., the system does not have the user's identification information. A detailed description of the above-mentioned system methods and features is now provided with reference to the figures.

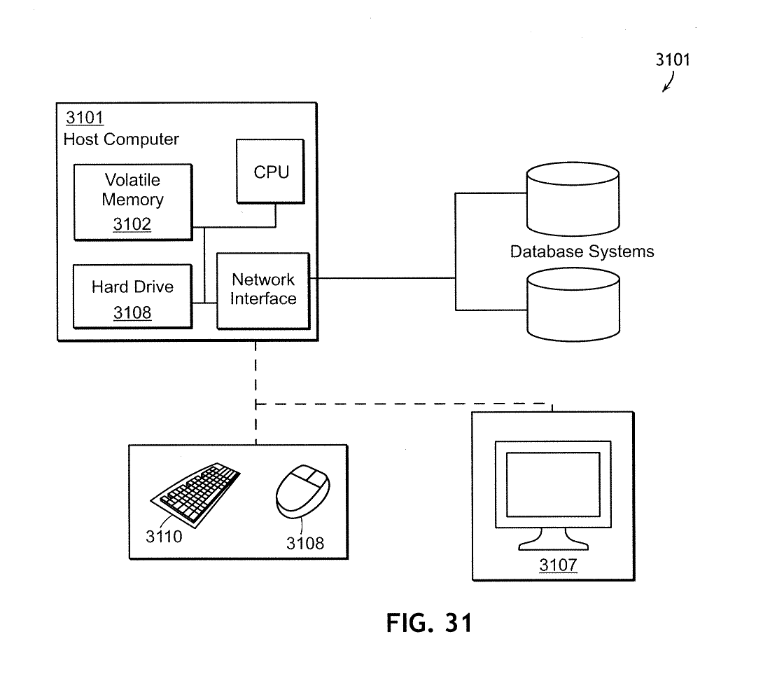

FIG. 31 is a diagram that depicts the various components of a computerized system for generating bonafide ratings, according to certain embodiments of the invention. The functional logic of the rating/review authentication and verification process is performed by a host computer, 3101 that contains volatile memory, 3102, a persistent storage device such as a hard drive, 3108, a processor, 3103, and a network interface, 3104. Using the network interface, the system computer can interact with databases, 3105, 3106. During the execution of the rating authentication and verification processes (including various risk determination algorithms), the computer extracts data from some of these databases, transforms it according to programmatic processes (e.g. rating review algorithms), and loads the transformed data into other databases. Although FIG. 31 illustrates a system in which the system computer is separate from the various databases, some or all of the databases may be housed within the host computer, eliminating the need for a network interface. The programmatic processes may be executed on a single host, as shown in FIG. 31, or they may be distributed across multiple hosts.

The host computer shown in FIG. 31 may serve as a recipient of active user input regarding the ratable object, the rating or various rater/reviewer profile and identity parameters. The host computer receives active user input from the active user's workstation. Workstations may be connected to a graphical display device, 3107, and to input devices such as a mouse 3109, and a keyboard, 3110. Alternately, the active user's work station may comprise a hand-held mobile communication device (e.g. cell phone, etc.) or other communication means. One embodiment of the present computer system includes a graphical environment that displays the aforementioned display web pages as interactive displays. This visual interface allows users of the system (raters/reviewers) to access the rating verification and authentication applications at a more intuitive level than, for example, a text-only interface. However, the techniques described herein may also be applied to any number of environments.

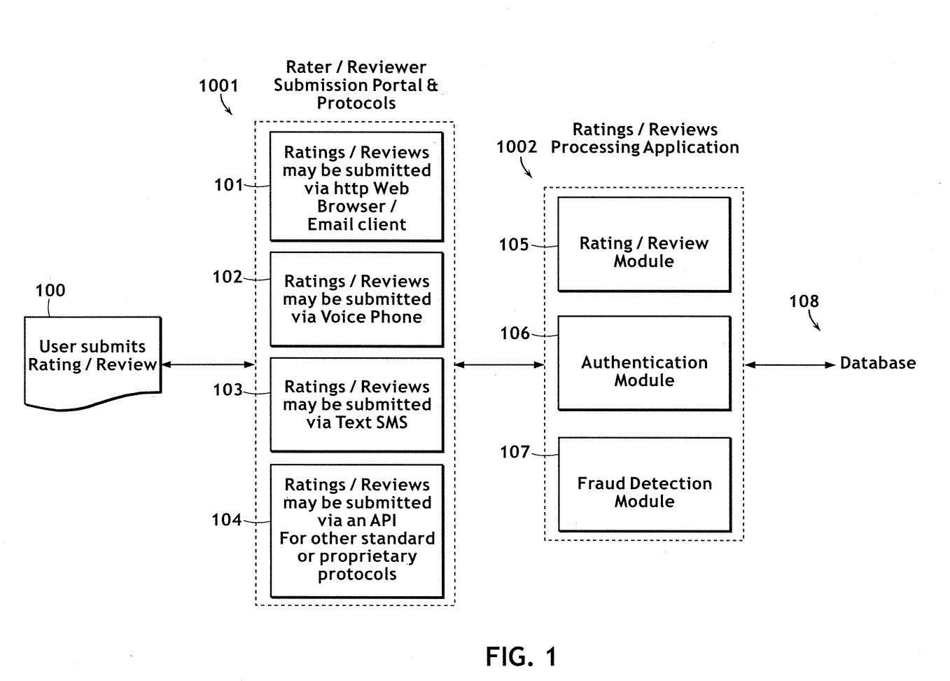

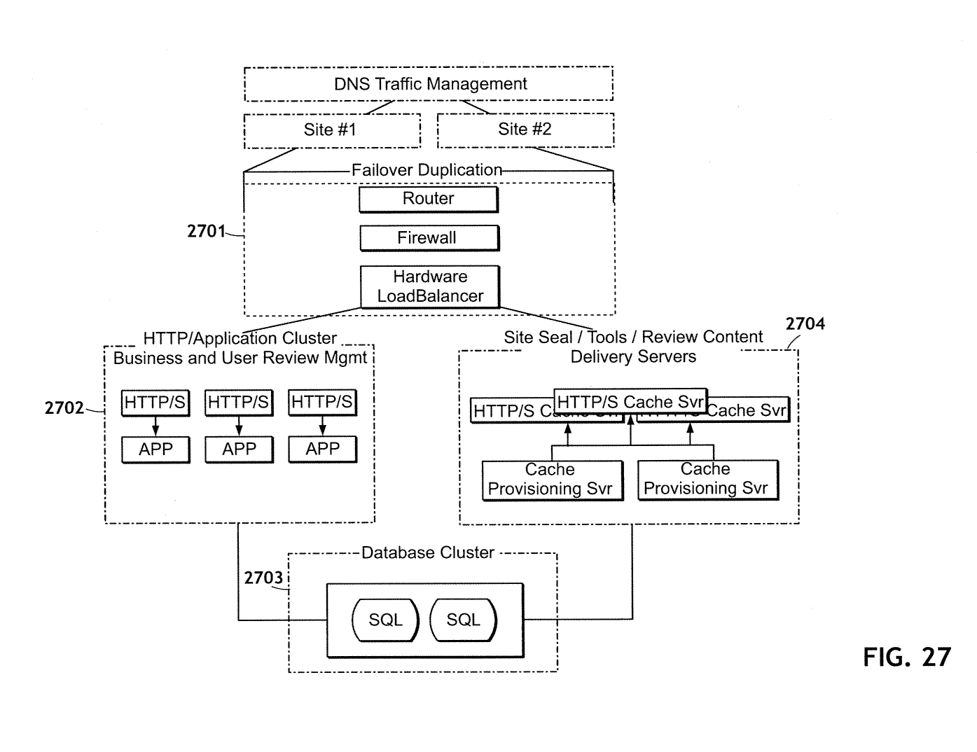

FIG. 1 shows the general architecture of a system that operates according to one embodiment. As shown in FIG. 1, the system enables a rater/reviewer to submit a rating/review via multiple protocols part 1001 and that are then processed through the Rating/Reviews Processing Application part 1002. A higher-level description of the complete rating system is provided with the present system, as shown in FIG. 27. The Rater/Reviewer Accepted Submission Protocols 1001 is represented in FIG. 27 as Rater/Reviewer Accepted Submission Protocols part 2702 and the Rating/Review Process Application 1002 is represented in FIG. 27 as Rating/Review Processing Application part 2702. The Rating/Reviews Processing Application 1002 can be hosted in physically separate computer systems or co-hosted in one physical computer system but logically separated with different web servers.

The Rater/Reviewer Accepted Submission Protocol part 1001 consist of four logical methods a user can submit a rating/review, a web browser based submission 101, a telephone based submission 102, a SMS (Short Message Service) based submission 103 and any other standard and proprietary protocols 104. The Ratings/Review Module 105 collects and processes the rating/review data. A database 108 is used to store all the information.

A user 100 using an http web browser or email client 101 to rate/review a ratable object will submit a rating/review to the system first. A user normally initializes the process by clicking on a hyperlinked image or textual hyperlink or may go directly to the appropriate URL to activate the rating/review process. The Ratings/Review Module 105 collects and processes the rating/review data. A database 108 is used to store all the information.

A user 100 may use a voice telephone based device 102 to rate/review a ratable object. A user normally initializes the rating/review process with a telephone network enabled device dialing a predetermined telephone number and inserting a unique numeric code of the ratable object. The system then instructs the user to submit the rating/review by using both telephone keypad and the rater/reviewer voice to collect the rating/review. The Ratings/Review Module 105 collects and processes the rating/review data. A database 108 is used to store all the information.

A user 100 may use a SMS (short message service) based device 103 to rate/review a ratable object. A user normally initializes the rating/review process with a mobile phone enabled SMS device by inserting a unique numeric code of the ratable object ID and sending it to a predefined telephone number or Short Code (a 5 or 6 digit number that is used in the United States to collect and send SMS messages). The Ratings/Review Module 105 collects and processes the rating/review data. A database 108 is used to store all the information.

A user 100 may also use a standard or proprietary protocol 104 to rate/review a ratable object. A developer may use the system API to create a new rating/review process for a protocol that is either standard or proprietary. The Ratings/Review Module 105 collects and processes the rating/review data. A database 108 is used to store all the information.

The Rating/Reviews Processing Application part 1002, collects, verifies and analyzes all user input and stores it in a database 108. It consists of three modules, a Rating and Review Module 105 that collects the user 100 rating/review data, a Authentication Module 106 that verifies and determines which user data to collect and a Fraud Detection Module 107 that analyzes user data to see if a potential fraudulent activity could exist. The database 108 is shared by the Rating/Review Processing Application 1002.

The Rating/Reviews Module 105, collects a user 100 rating/review data and stores it in a database 108. The module dynamically determines which data to collect based on the analysis of the Fraud Detection Module 107.

The Authentication Module 106 verifies the user's rating/review data to ensure the data is real. The Authentication Module 106 also dynamically instructs the Rating/Review Module 105 to collect more or less data elements from the rater/review 100 depending on the analysis of processing the user data from the Fraud Detection Module 107.

The Fraud Detection Module 107 analyzes the user's rating/review data to determine if potential fraudulent activity is occurring. The Fraud Detection Module has many algorithms that can potentially determine fraudulent activity, if one or more of these algorithms indicate that potential fraudulent activity is occurring then it notifies the Authentication Module 106 which may take appropriate steps to ask for and verify additional data from the rater/reviewer user 100 to reduce the fraudulent activity. Methods for determining potential fraudulent activity are described below.

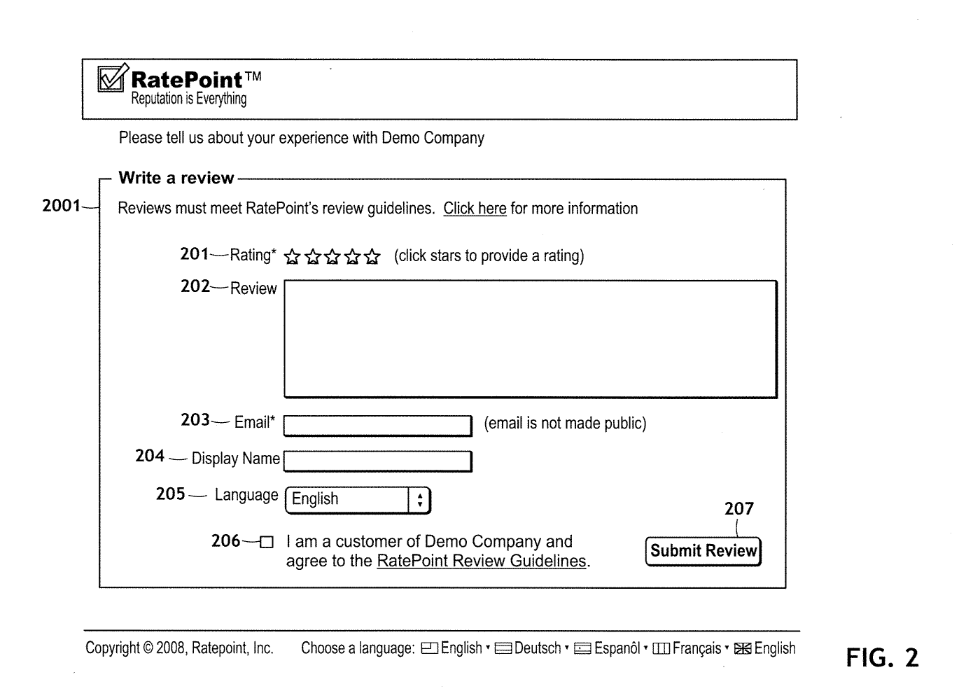

FIG. 2 illustrates an exemplary embodiment of initializing a Rating/Review Submission Portal and Protocol 1001 using an http Web Browser or email client 102. The Rating/Review submission page part 2001, request the rater/reviewer to provide a minimum of 3 pieces of data. The first piece of requested data is the Star Rating part 201 where the user may select between 1 star and 5 stars where 1 star is the lowest (least satisfied) and 5 stars is the highest (most satisfied) rating. The second piece of requested data is the email address of the rater/reviewer part 203 where the user should insert an email address that is immediately accessible by the rater/reviewer. The third piece of requested data is the check box of the rater/reviewer agreeing to the guidelines of the service part 206. Once all three of these data points are properly filled in a rating/review can be successfully submitted using the Submit Review button part 207. Additionally, a user may provide more qualitative review data part 202 that can provide more insight as to why the rating 201 was selected. A Display Name part 204 can also be added that allows the user to provide more identifiable information about them that may add more credibility with other users of this review in the future. The review can be written in any language. The system will automatically detect the language being used to write a rating/review base of the primary language set in the web browser preferences, but if the user is writing in a different language than the one set in the browser, then the rater/reviewer may select the proper Language part 205.

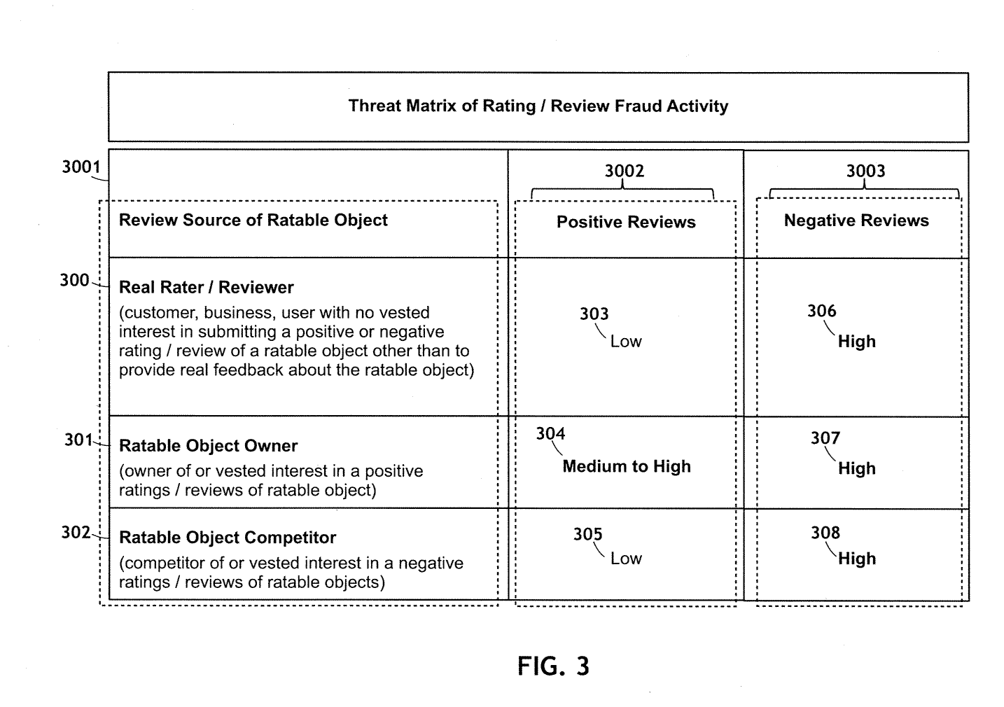

FIG. 3 illustrates the system and method to determine the Threat Matrix of Rating/Review Fraud Activity. Understanding the potential source and reason when fraudulent ratings/reviews are submitted is paramount to determining a system and method by which to prevent fraudulent rating/review activity. The Threat Matrix of Rating/Review Fraud Activity breaks the source threats into three groups, each group having a specified level of risk that the rating is fraudulent. The first group identifies the Review Source of the Ratable Object part 3001. Depending on who is submitting a rating/review and/or if there is a vested interest in submitting a rating/review the Review Source of the Ratable Object 3001 can be broken down into 3 sources. The first source is a Real Rater/Reviewer part 300. This source is a bonafide review source and does not have a vested interest in submitting a positive or negative review other than sharing a genuine experience about the ratable object. The second source is a Ratable Object Owner part 301. This source may have a vested interest in submitting a positive rating/review. This may misrepresent the ratable object and may also lead a future user of the rating or review to make a misinformed decision about the ratable object. The third source is a Ratable Object Competitor part 302.

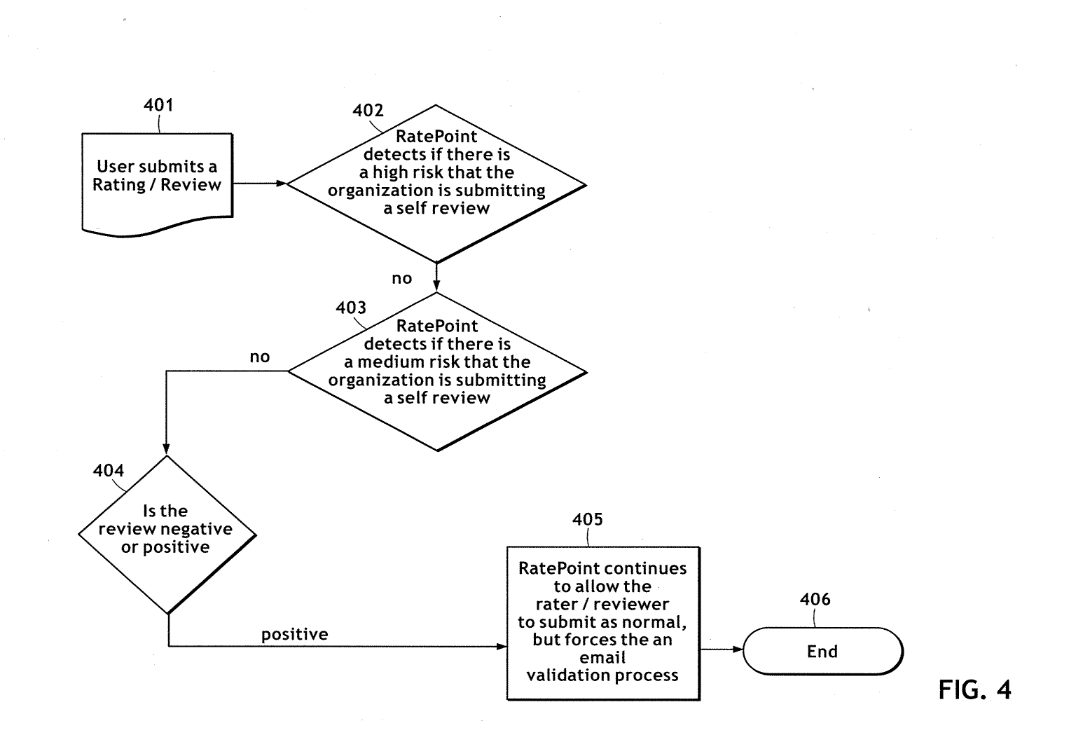

This third source may have a vested interest in submitting a negative rating/review. The submission of a biased review may result in a rating that misrepresent the ratable object and may also lead a future user of the rating or review to make a misinformed decision about the ratable object. The second group identifies if the rating/review is a Positive Review part 3002. The system identifies positive reviews as being 3, 4 or 5 in the Rating selection 201. The third group identifies if the rating/review is a Negative Review part 3003. The system identifies a negative review as being a 1 or 2 in the Rating selection 201. The system focuses on the two primary rating/review fraud threats. The first is a positive review based on the evaluation that there is a medium to high risk that the Ratable Object Owner 301 may be submitting a positive rating/review 304 to the system. Under this situation, the information being submitted will undergo additional authentication and potentially stopped. FIG. 4 described the system flow to prevent this situation from occurring. The second is a negative review because there is a medium risk that the Ratable Object Competitor 302 can submit a negative rating/review 308 to the system without detecting fraud activity. Therefore, the system also treats cells 306 and 307 as medium risk because it is more difficult to detect fraud activity for Ratable Object Competitor submitting negative rating/reviews. Under this situation, the information being submitted will undergo additional authentication in order to prevent this type of fraud activity. FIG. 4 describes the system flow to prevent this situation from occurring. The chances of fraud activity in the other cells of the matrix are low, because the rater/reviewer does not have a vested interest to submit either a positive or negative rating/review in the other cells parts 303 or 305.

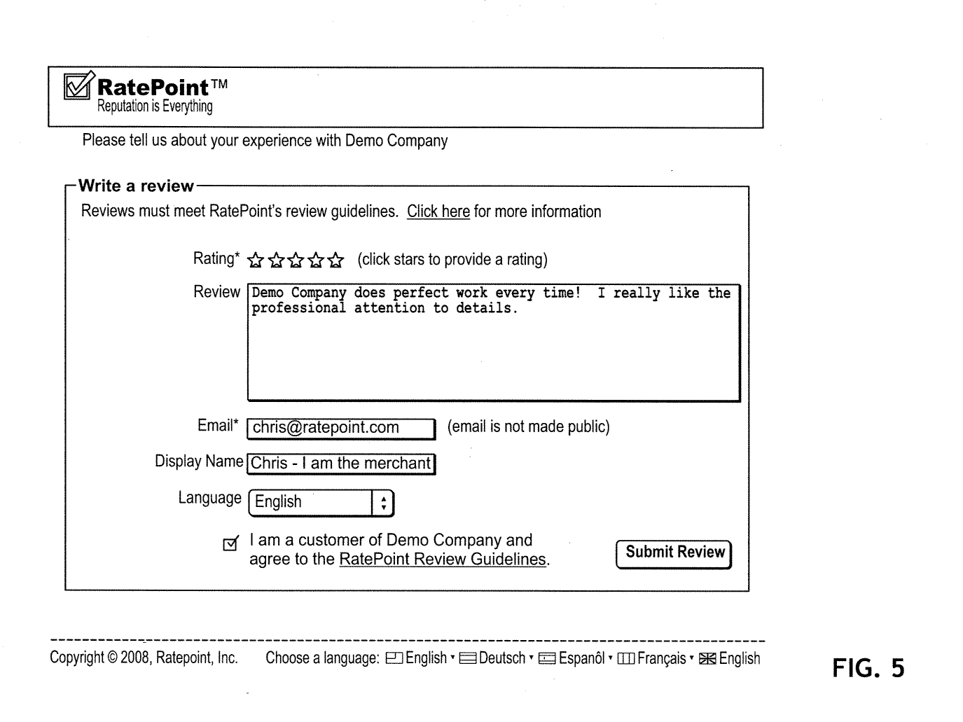

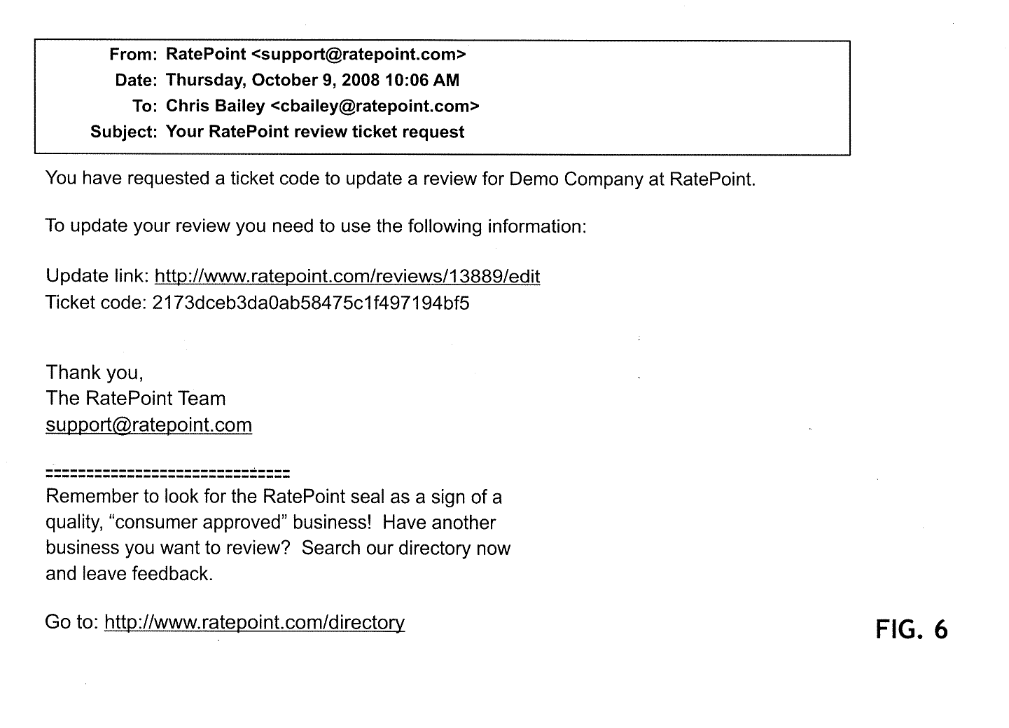

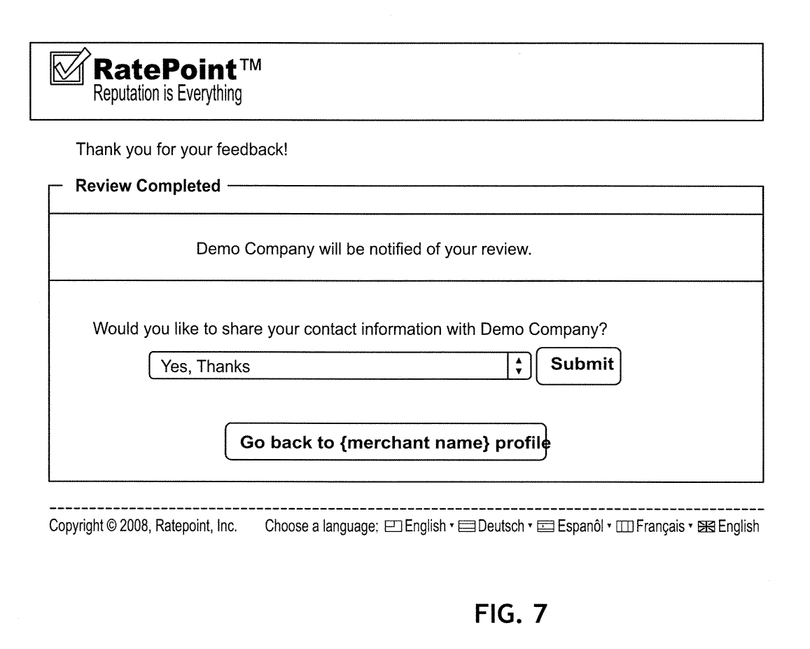

FIG. 4 illustrates a block diagram showing an exemplary system to submit a positive user rating/review 3002 from a Real Reviewer 300 or a Ratable Object Competitor 302 via the Rating/Review submission portal & protocols 1001 of the system. When a user submits a review part 401 via a web browser 101, a web page FIG. 2 is presented to the user. Once the user properly fills out the Rating 201, the email address 203, and the agreement to the system guidelines 206, the user may submit the review 207 as seen in FIG. 5. The system will analyze the data from the submission with the Fraud Detection Module 107 and inform the Authentication Module 106 if it has detected a high risk of Fraud Activity part 402. If no high levels of Fraud Activity are detected, the system continues to search for medium levels of fraud activity with the Fraud Detection Module 107. If no medium risk of fraud is found part 403 then this information is communicated to the Authentication module 106. The system will then determine if the rating/review is positive or negative part 404. A positive rating/review is marked with a 3, 4 or 5 rating 201, while a negative rating/review is marked with a 1 or 2 rating 201. If the rating is positive and the system determines that the fraud risk is low, then the rater/review is allowed to continue to submit the rating/review as normal part 405. Then requesting the user verify their email address by sending an email with a verification code or hyperlink as seen in FIG. 6 that when provided by the user back to the system verifies that the user has control over the email address. Once the user has completed this process part 406. The rater/reviewer is notified of the success by an email, SMS, telephone and/or web based transaction success/thank you page as seen in FIG. 7.

FIG. 5 illustrates an exemplary embodiment of a Positive Rating/Review Submission using an http Web Browser 102. Once the rater/reviewer submits the review 207 the email 203 supplied by the rater/reviewer will be immediately verified by the rater/reviewer. The system sends a email verification 405 to the address listed in email 203.

FIG. 6 illustrates an exemplary embodiment of a verification that is sent to the rater/reviewer's email address. The system supplies a unique code that the user my either cut and past or click a hyperlink in an enabled email client to confirm access to the email address. Once this process is done, the rater/reviewer will be taken to a Confirmation/Thank You page FIG. 7.

FIG. 7 illustrates an exemplary embodiment of a Confirmation/Thank You page that indicates that a successful rating or review has been submitted for the Ratable Object.

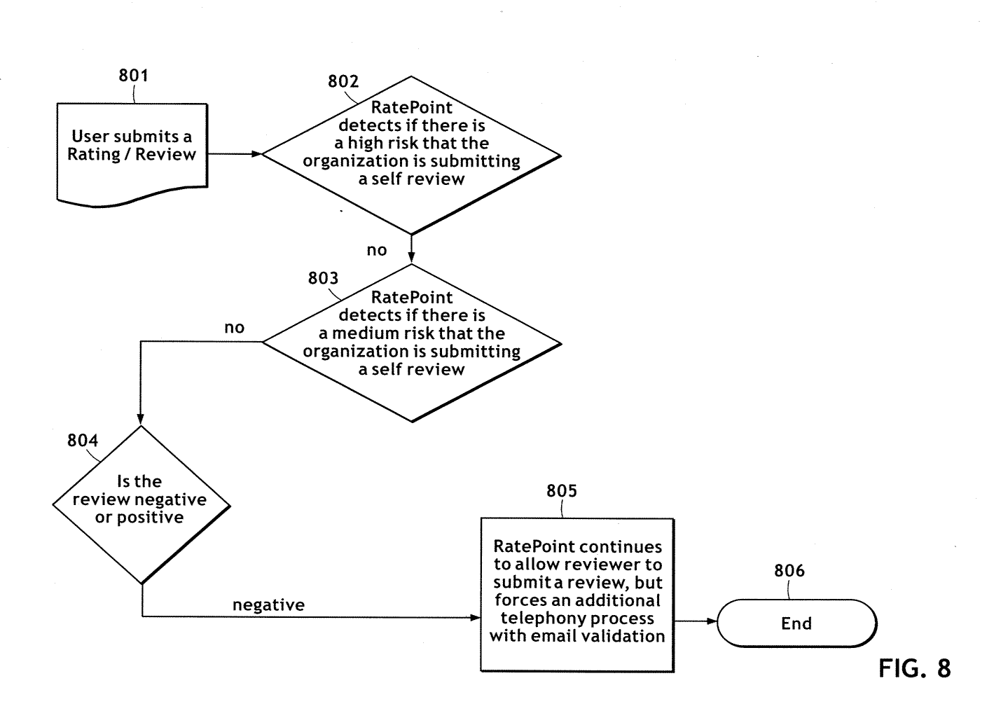

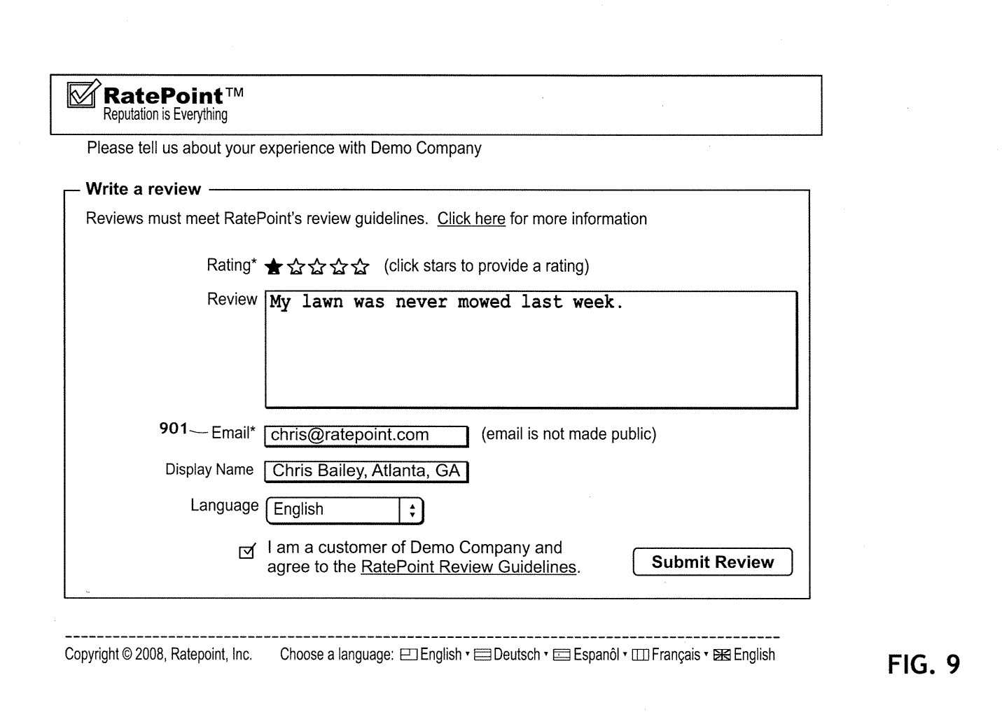

FIG. 8 illustrates a block diagram showing an exemplary system to submit a negative user rating/review 3003 from a Ratable Object Competitor 302 via the Rating/Review submission portal & protocols 1001 of the system. Because the fraud detection can be avoided by the Ratable Object Competitor 302 more easily than the Ratable Object Owner 302 and the Real Rater/Review 301, the system and method is applied to all Negative Reviews 3003. When a user submits a review part 801 via a web browser 101, a web page FIG. 2 is presented to the user. Once the user properly fills out the Rating 201, the email address 203, and the agreement to the system guidelines 206, the user may submit the review 207 as seen in FIG. 9. The system will analyze the data from the submission with the Fraud Detection Module 107 and inform the Authentication Module 106 if it has detected a high risk of Fraud Activity part 802. If no high levels of Fraud Activity are detected, the system continues to search for medium levels of fraud activity with the Fraud Detection Module 107. If no medium risk of fraud is found part 803 then this information is communicated to the Authentication module 106.

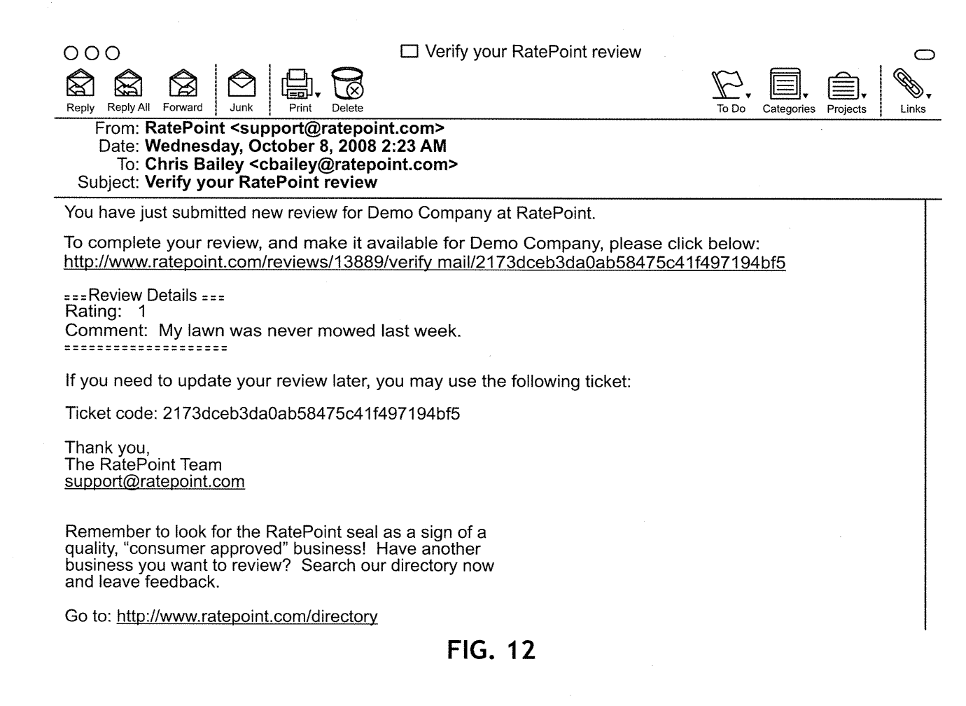

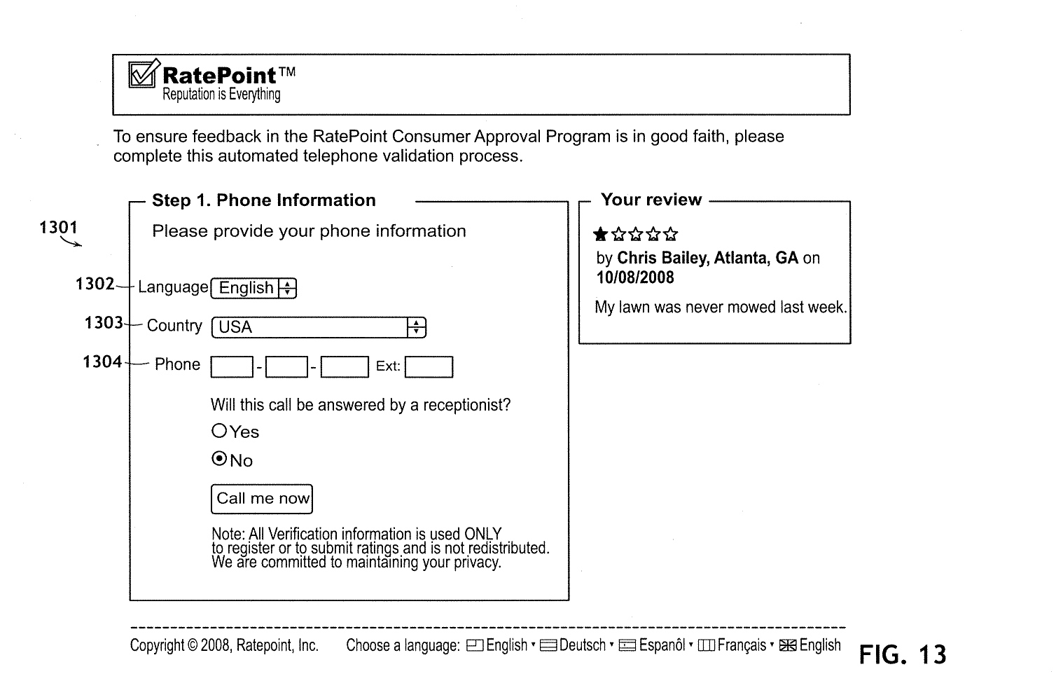

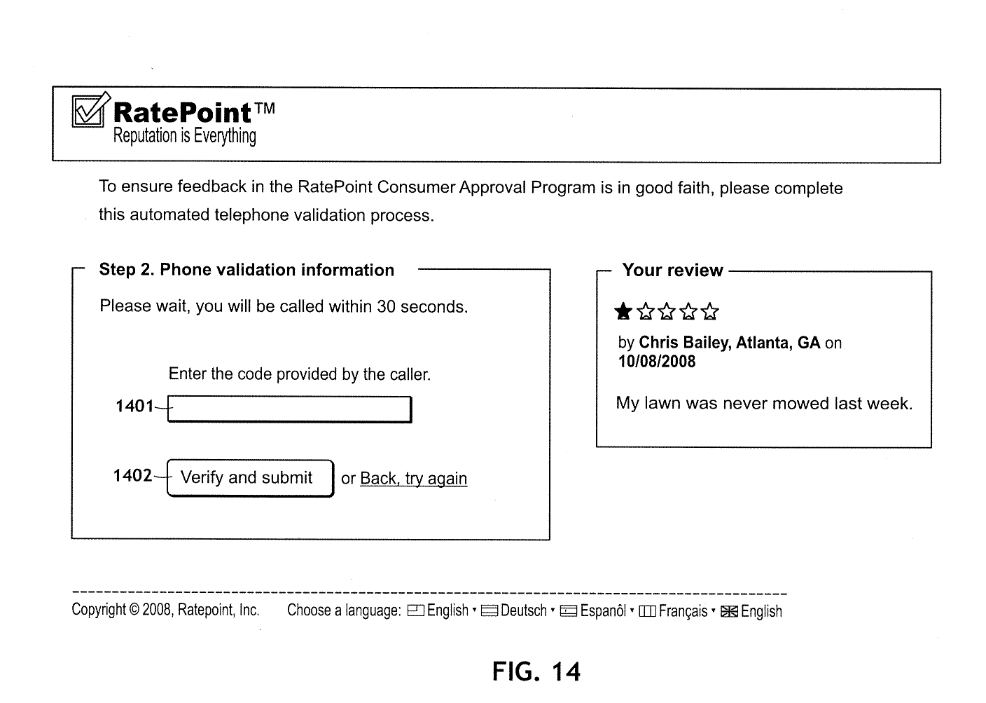

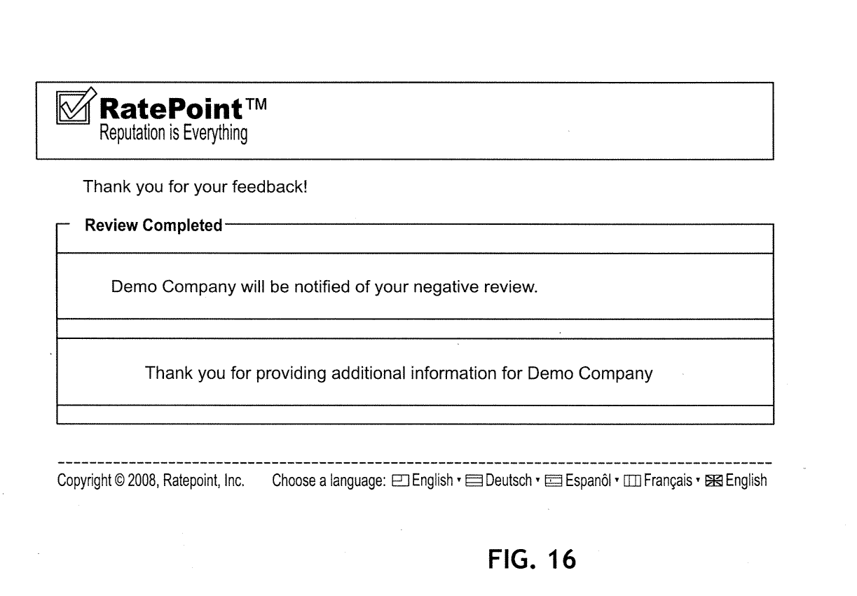

The system will then determine if the rating/review is positive or negative part 804. A positive rating/review is marked with a 3, 4 or 5 rating 201, while a negative rating/review is marked with a 1 or 2 rating 201. If the rating is negative, the system determines that the fraud risk is medium and allows the rater/review to continue to submit the rating/review, but through an additional amount of vetting including a real time telephone call back to the rater/reviewer part 805. The system requests the user verify their email address by sending an email with a verification code or hyperlink as seen in FIG. 12 that when provided by the user back to the system it verifies that the user has control over the email address. The system also ensures that an out of band telephone call is place to the User FIG. 13, the user will be give a code over the phone that may be applied in the verification field to ensure that the person that has access to a telephone number as well FIG. 14. Once the user has completed this process part 805, the rater/reviewer is notified of the success by an email, sms, telephone, and/or web based transaction success/thank you page as seen in FIG. 16, which completes the process part 806.

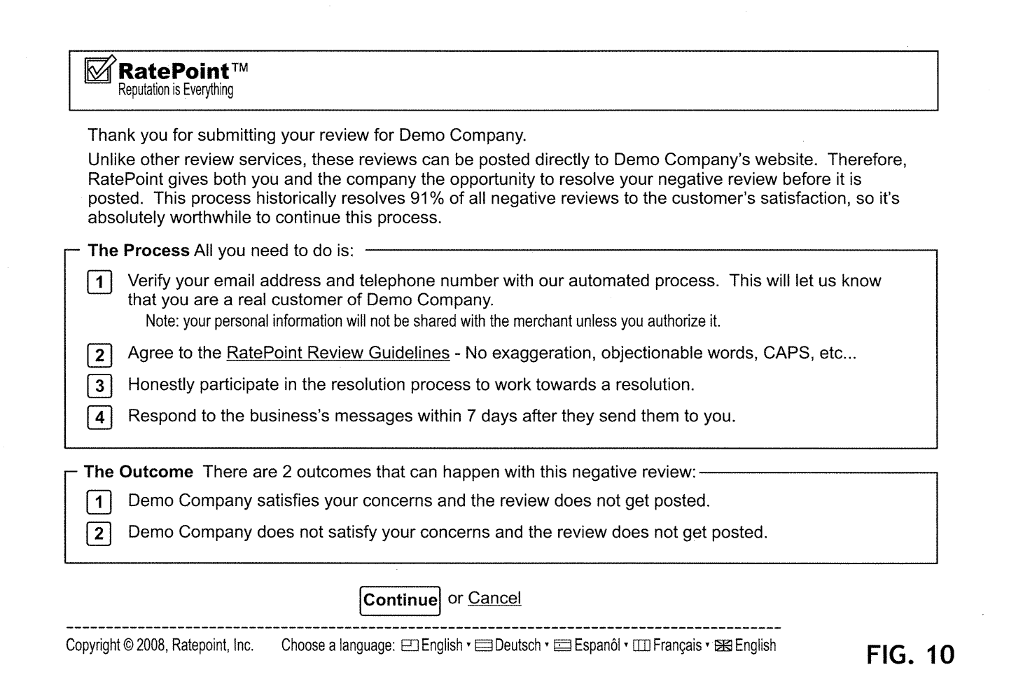

FIG. 9 illustrates an exemplary embodiment of a Negative Rating/Review Submission using an http Web Browser 102. Once the rater/reviewer submits the review 207, agreement request page illustrated in FIG. 10 will display.

FIG. 10 illustrates an exemplary embodiment of a rater/reviewer agreeing to the system policy and guidelines. One the rater/reviewer submit agrees the process will continue and the email 901 supplied by the rater/reviewer will be immediately verified by the rater/reviewer. The system sends a email verification 805 to the address listed in email 901.

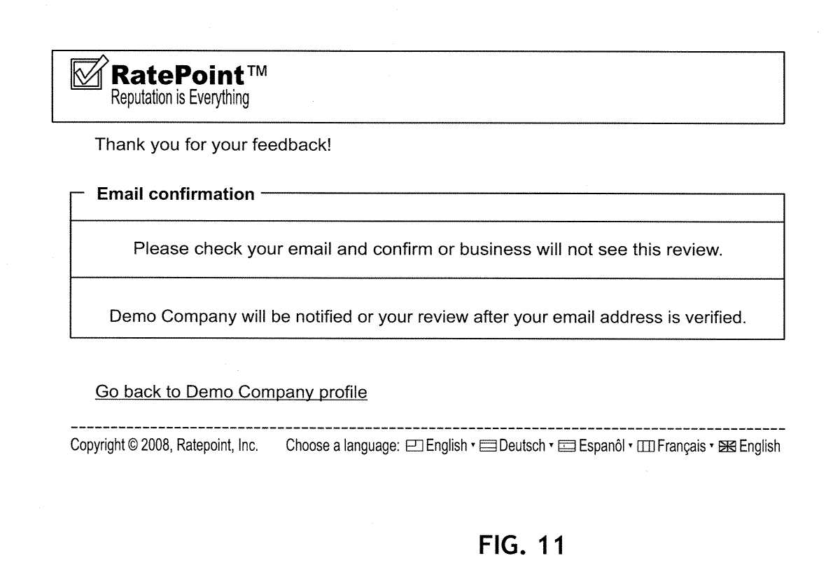

FIG. 11 illustrates an exemplary embodiment in which a verification email was sent to the rater/reviewer. The verification email requests the user validate/verify the process in order to continue the rating/review.

FIG. 12 illustrates an exemplary embodiment of a verification that is sent to the rater/reviewer's email address. The system supplies a unique code that the user my either cut and past or click the hyperlink in an enabled email client to confirm access to the email address. Once this process is complete, the rater/reviewer will be taken directly to phone verification page FIG. 13.

FIG. 13 illustrates an exemplary embodiment of a Phone Verification Page that will make an automated real-time telephone call back to the rater/reviewer and supply a numeric code once the appropriate data has been provided. The Language part 1301 to determined by the browser language preferences but can be superseded by selecting this options from the drop down. This selection will determine which spoken language to be used when the automated real-time telephone call back is made. The Country part 1302 determines how to construct the dialing of the telephone number. The phone number and extension part 1303 collects the actual telephone number and extension to call the rater/review. While part 1304 asks the user if a receptionist will answer the call, if selected yes, the system will verbally asked to be forwarded to the correct extension. Once the information is submitted the rater/reviewer will be redirected to a new page FIG. 14 and receive an automated real-time telephone call.

FIG. 14 illustrates an exemplary embodiment of the Phone Verification system asking the user to enter the code that was just supplied by the automated real-time telephone call back system. The user is requested to provide and submit a unique numerical code from the real time call back in order to continue the rating/review process. According to the present embodiment the telephone call supplied a numeric code that may be entered into the verification field part 1401. Once that is complete the rater/review may Verify and Submit part 1402 their code results to the system. The code is checked for accuracy and, if accurate, determined successful. If successful, the review is now submitted however, the rater/review may insert additional information to the Ratable Object owner to help them understand the negative rating/review that was just submitted.

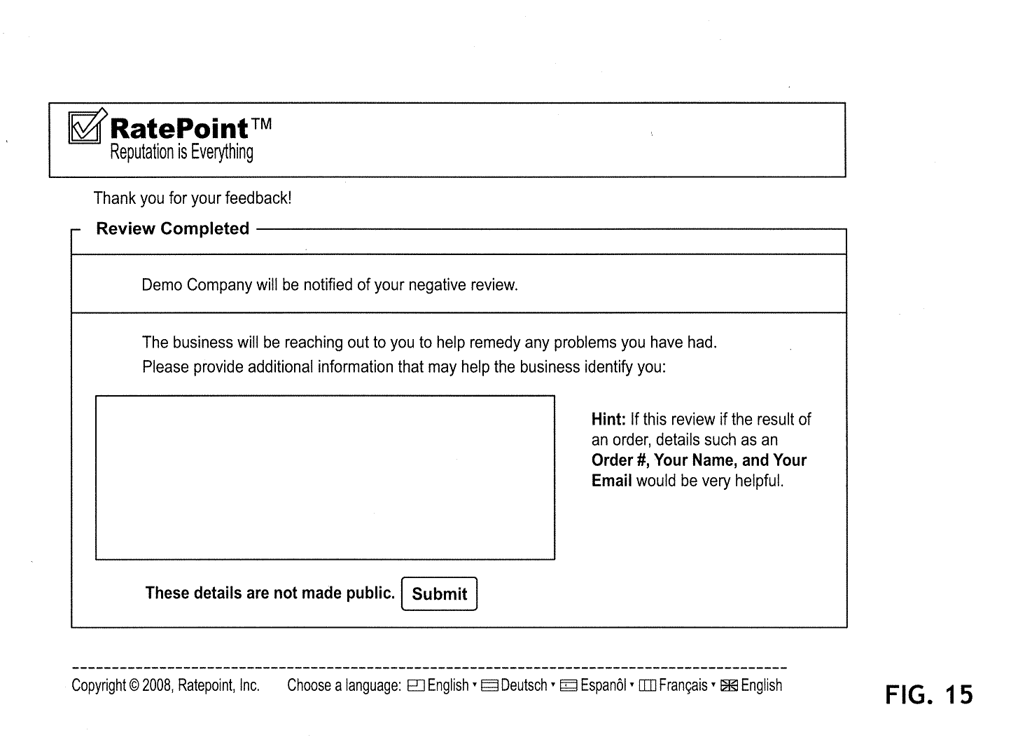

FIG. 15 illustrates an exemplary embodiment of the rater/review's option to provide additional information to the Ratable Object owner to help them understand the negative rating/review that was just submitted. Once this rater/review is satisfied with the information provide, they click the Submit button to continue the process.

FIG. 16 illustrates an exemplary embodiment of a Confirmation/Thank You page that indicates that a successful rating or review has been submitted for the Ratable Object.

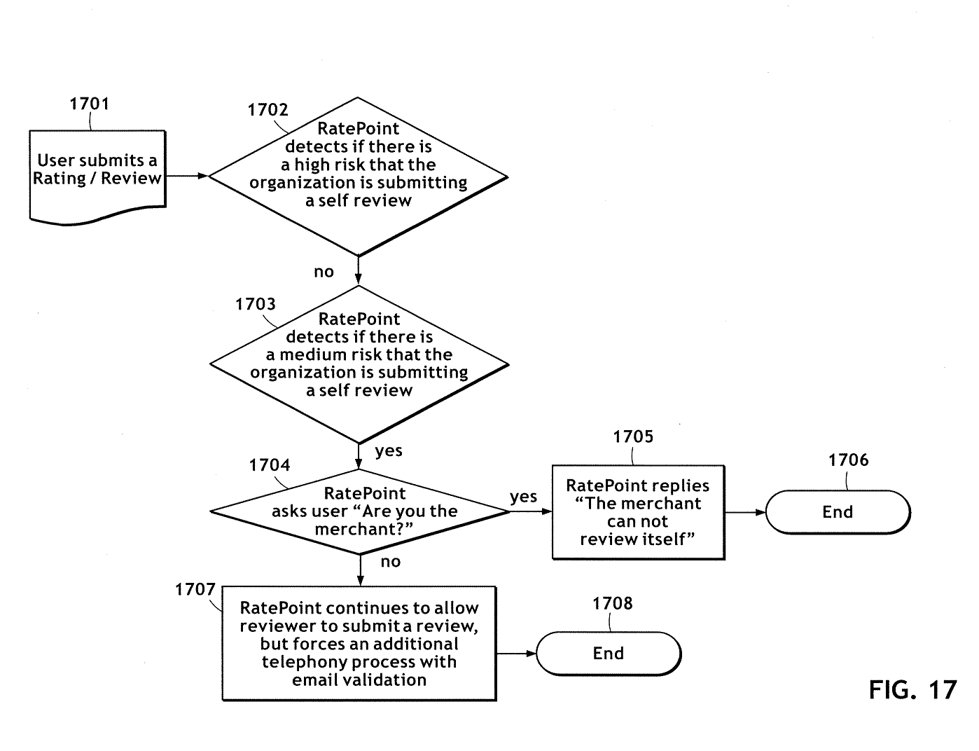

FIG. 17 illustrates a block diagram showing an exemplary system to submit a positive user rating/review 3002 from a Ratable Object Owner 301 via the Rating/Review submission portal & protocols 1001 of the system. When a user submits a review part 1701 via a web browser 101, a web page FIG. 2 is presented to the user. Once the user properly fills out the Rating 201, the email address 203, and the agreement to the system guidelines 206, the user may submit the review 207 as seen in FIG. 5. The system will analyze the data from the submission with the Fraud Detection Module 107 and inform the Authentication Module 106 if it has detected a high risk of Fraud Activity part 1702. If no high levels of Fraud Activity are detected, the system continues to search for medium levels of fraud activity with the Fraud Detection Module 107. If medium risk of fraud is found part 1703 then this information is communicated to the Authentication module 106.

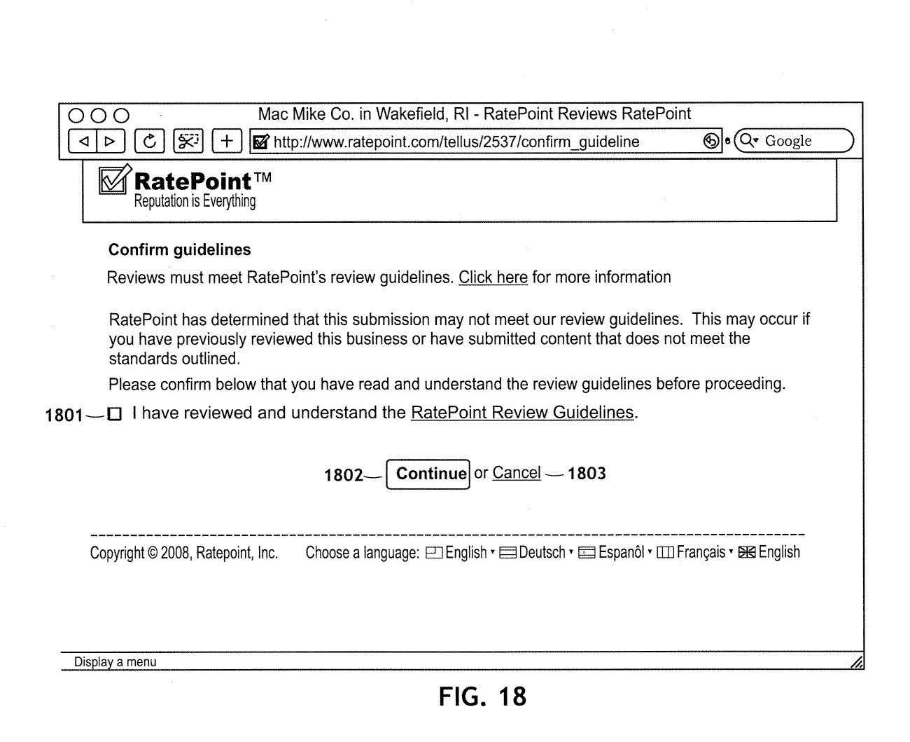

The system will then ask the user if they are the owner of the ratable object part 1704 as exemplified in FIG. 18. If the rater/review does not agree to the terms and guidelines of the system or cancels the rating/review then the rater/review is notified that the ratable object owner may not rate themselves part 1705 and the process ends part 1706 without saving the review. If the rater or reviewer does agree to the terms and guidelines, then the, system allows the rater/review to continue to submit the rating/review, but through an additional amount of vetting including a real time telephone call back to the rater/reviewer part 1707. The system requests the user verify their email address by sending an email with a verification code or hyperlink as seen in FIG. 12 that when provided by the user back to the system it verifies that the user has control over the email address. The system also ensures that an out of band telephone call is place to the User FIG. 13, the user will be give a code over the phone that may be applied in the verification field to ensure that the person that has access to a telephone number as well as seen in FIG. 14. Once the user has completed this process part 1707, the rater/reviewer is notified of the success by an email, sms, and/or web based transaction success/thank you page as seen in FIG. 16, which completes the process part 1708.

FIG. 18 illustrates an exemplary embodiment asking the suspected ratable object owner of agreeing that they are not the ratable object owner and other system guidelines part 1801. If the rater/reviewer selects Continue part 1802 then the process will continue in the same order as in FIG. 11, FIG. 12, FIG. 13, FIG. 14, FIG. 15 and FIG. 16.

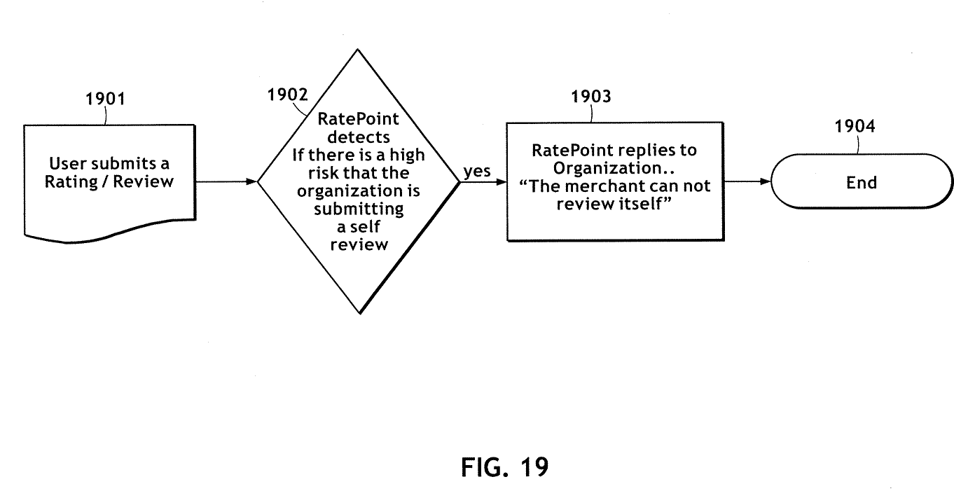

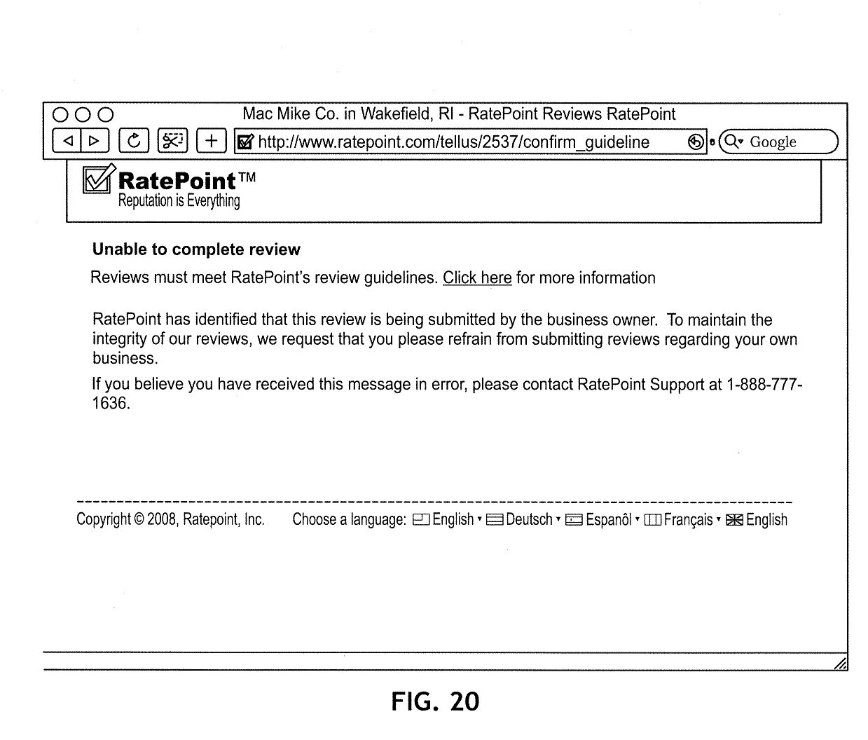

FIG. 19 illustrates a block diagram showing an exemplary system to submit a positive user rating/review 3002 from a Ratable Object Owner 301 via the Rating/Review submission portal & protocols 1001 of the system. When a user submits a review part 1901 via a web browser 101, a web page FIG. 2 is presented to the user. Once the user properly fills out the Rating 201, the email address 203, and the agreement to the system guidelines 206, the user may submit the review 207 as seen in FIG. 5. The system will analyze the data from the submission with the Fraud Detection Module 107 and inform the Authentication Module 106 if it has detected a high risk of Fraud Activity part 1902. If high levels of Fraud Activity are detected, the system will block the rating/review submission part 1903 and exemplified in FIG. 20. At this point the process ends part 1904.

FIG. 20 illustrates an exemplary embodiment of blocking the rating/review submission of a known ratable object owner. When the process ends, as depicted in element 1904 of the preceding figure, the rater/reviewer will encounter the display of FIG. 20, informing the rater/review that the rating will not be accepted.

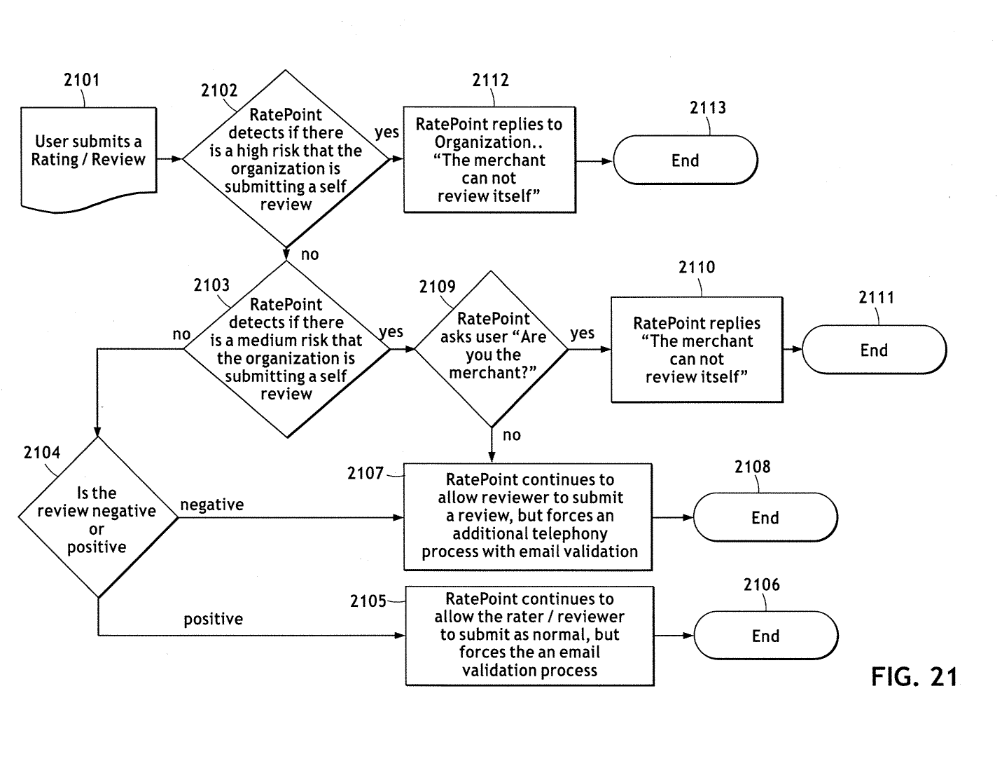

FIG. 21 illustrates a block diagram showing the combined exemplary systems depicted in FIG. 4, FIG. 8, FIG. 17, and FIG. 19. Specifically, FIG. 21 illustrates a block diagram showing a process flow for the entire system, by which an active user submits a rating/review 3002 from a Review Source 3001 via the Rating/Review submission portal & and protocols 1001 of the system. A synopsis of each alternate path is provided.

In the first path, when a user submits a positive review part 2101 via a web browser 101, a web page FIG. 2 is presented to the user. Once the user properly fills out the Rating 201, the email address 203, and the agreement to the system guidelines 206, the user may submit the review 207 as seen in FIG. 5. The system will analyze the data from the submission with the Fraud Detection Module 107 and inform the Authentication Module 106 if it has detected a high risk of Fraud Activity part 2102. If no high levels of Fraud Activity are detected, the system continues to search for medium levels of fraud activity with the Fraud Detection Module 107. If no medium risk of fraud is found part 2103 then this information is communicated to the Authentication module 106. The system will then determine if the rating/review is positive or negative, 2104. A positive rating/review is marked with a 3, 4 or 5 rating 201 or other suitable measurement, while a negative rating/review is marked with a 1 or 2 rating 201 or other suitable measurement. If the rating is positive and the system determines that the fraud risk is low, then the rater/review is allowed to continue to submit the rating/review as normal part 2105. The system then requests the user verify their email address by sending an email with a verification code or hyperlink as seen in FIG. 6. When the active user returns the verification code or hyperlink back to the system, the system verifies that the user has control over the email address. Once the user has completed this process, part 2106, the rater/reviewer is notified of the success by an email, sms, telephone and/or web based transaction success/thank you page as seen in FIG. 7.

A second alternative path is executed when a user submits a negative review part 2101 via a web browser 101, a web page FIG. 2 is presented to the user. Once the user properly fills out the Rating 201, the email address 203, and the agreement to the system guidelines 206, the user may submit the review 207, as seen in FIG. 9. The system will analyze the data from the submission with the fraud Detection Module 107 and inform the Authentication Module 106 if it has detected a high risk of Fraud Activity part 2102. If no high levels of Fraud Activity are detected, the system continues to search for medium levels of fraud activity with the Fraud Detection Module 107. If no medium risk of fraud is found part 2103, then this information is communicated to the Authentication module 106. The system will then determine if the rating/review is positive or negative, 2104. A positive rating/review is marked with a 3, 4 or 5 rating 201, or other suitable ranking. A negative rating/review is marked with a 1 or 2 rating 201, or other suitable ranking.

If the rating is negative, the system determines that the fraud risk is medium and allows the rater/review to continue to submit the rating/review, but implements an additional amount of vetting. The additional vetting can include a real time telephone call back to the rater/reviewer part 2107. The system requests the user verify their email address by sending an email with a verification code or hyperlink as seen in FIG. 12. The user returns the verification code or hyperlink to the system to verify that the user has control over the email address. The system also ensures that an out-of-band telephone call is place to the User as seem in FIG. 13. The user will be given a code over the phone to apply in the verification field and thereby ensure that the person has access to the identified telephone number as well (FIG. 14). Once the user has completed this process part 2107, the rater/reviewer is notified of the success by an email, SMS, telephone, and/or web based transaction success/thank you page as seen in FIG. 16, which completes the process part 2108.

A third alternative path is enacted when a user submits positive a user rating/review 3002 from a Ratable Object Owner 301 via the Rating/Review submission portal & protocols 1001 of the system. When a user submits a review part 2101 via a web browser 101, a web page FIG. 2 is presented to the user. Once the user properly fills out the Rating 201, the email address 203, and the agreement to the system guidelines 206, the user may submit the review 207 as seen in FIG. 5. The system will analyze the data from the submission with the Fraud Detection Module 107 and inform the Authentication Module 106 if it has detected a high risk of Fraud Activity part 1702. If no high levels of Fraud Activity are detected, the system continues to search for medium levels of fraud activity with the Fraud Detection Module 107. If medium risk of fraud is found, 2103, then this information is communicated to the Authentication module 106.

The system will then ask the user if they are the owner of the ratable object, 2109, as exemplified in FIG. 18. If the rater/review does not agree to the terms and guidelines of the system or cancels the rating/review then the rater/review is notified that the ratable object owner may not rate themselves part 2110 and the process ends part 2111 without saving the review. If the rater or reviewer does agree to the terms and guidelines, then the, system allows the rater/review to continue to submit the rating/review, but through an additional amount of vetting.

The additional vetting process includes a real time telephone call back to the rater/reviewer part 2107. The system requests the user verify their email address by sending an email with a verification code or hyperlink as seen in FIG. 12. When the verification code or hyperlink is returned by the user, the system verifies that the user has control over the email address. The system also ensures that an out of band telephone call is place to the User FIG. 13, the user will be given a numeric code over the phone that may be applied in the verification field to ensure that the person that has access to a telephone number as well as seen in FIG. 14. Once the user has completed this process part 2107, the rater/reviewer is notified of the success by an email, SMS, and/or web based transaction success/thank you page as seen in FIG. 16, which completes the process part 2108.

A fourth alternative path is implemented when a user submits a positive user rating/review 3002 from a ratable Object Owner 301 via the Rating/Review submission portal & protocols 1001 of the system. When a user submits a review part 2101 via a web browser 101, a web page FIG. 2 is presented to the user. Once the user properly fills out the Rating 201, the email address 203, and the agreement to the system guidelines 206, the user may submit the review 207 as seen in FIG. 5. The system will analyze the data from the submission with the Fraud Detection Module 107 and inform the Authentication Module 106 if it has detected a high risk of Fraud Activity part 2102. If high levels of Fraud Activity are detected, the system will block the rating/review submission part 2112 and exemplified in FIG. 20. At this point the process ends part 2113.

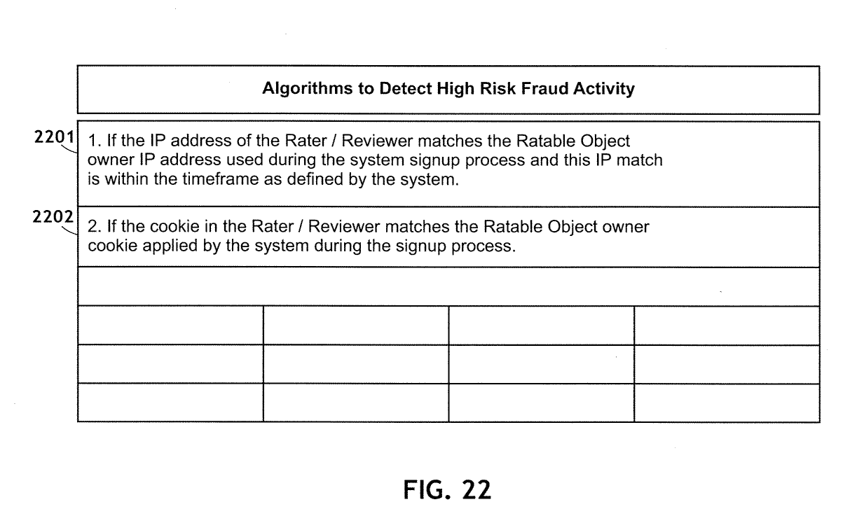

FIG. 22 illustrates a table diagram showing exemplary system algorithms to detect high-risk fraud activity. When a user submits a review part 1901 via a web browser 101. The system will analyze the data from the submission with the Fraud Detection Module 107 and inform the Authentication Module 106 if it has detected a high risk of Fraud Activity part 1902. The high risk of fraud activity is generated when any of the algorithms part 2201 and 2202 trigger a fraud alert. Note that the parameters may be selected according to a variety of criteria depending on the characteristics of the ratable object, characteristics of the authentication/verification standard, expected level of risk and/or any other appropriate criteria.

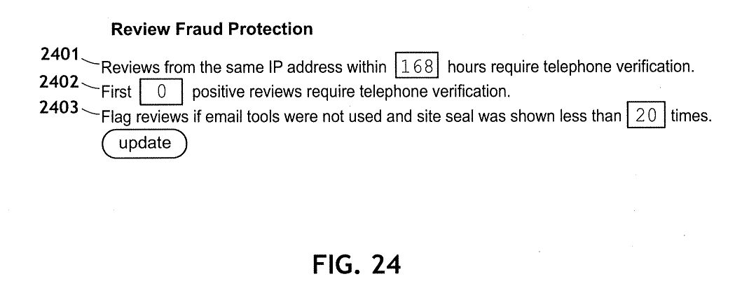

The first algorithm 2201 works as follows: if a Rater/Reviewer's IP address is determined to be the same as the IP address of the ratable object owner that is recorded during a signup stage or the IP address that is recorded from the ratable object owner during a login event to manage their ratable object account, then the system implements algorithm 2201. The system determines time duration elapsed between these two IP addresses from when they were last recorded is less than or equal to X hours (as defined in the system FIG. 24). If the time elapsed between the two events is less than or equal to X hours, then system blocks reviewer 1903. When the system blocks the reviewer 1903 it provides a notification, as exemplified in FIG. 20.

The second algorithm 2202 works as follows: if a Rater/Reviewer cookie (a unique code that the system applies to the user's web browser) is determined to be the same as the cookie that was applied by the system during signup of the ratable objects owner during a login event to the system in order to manage their ratable object account, then the system blocks the reviewer 1903. When the system blocks the reviewer 1903 it provides a notification, as exemplified in FIG. 20. One of skill in the art will appreciate that the second algorithm may be easily implemented through a variety of computerized software/hardware components and need not be discussed in the present disclosure.

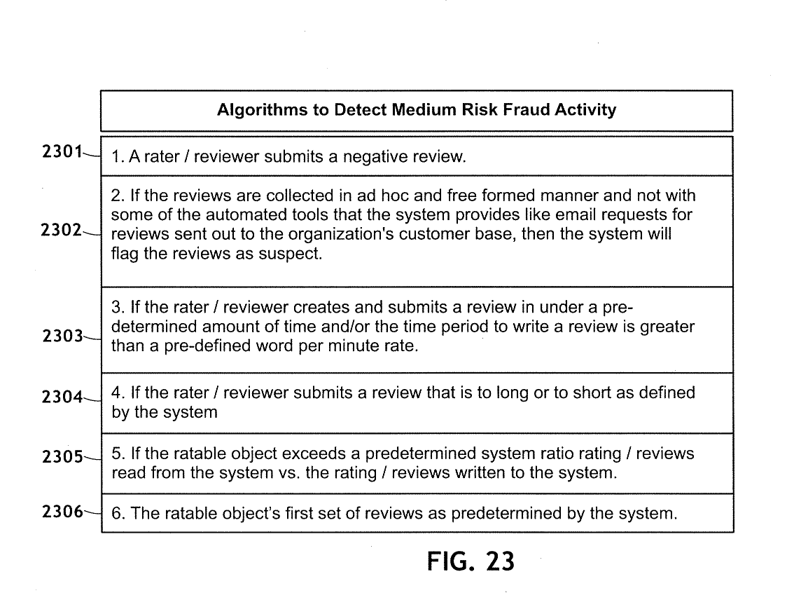

FIG. 23 illustrates a table diagram showing exemplary system algorithms to detect medium-risk fraud activity. When a user submits a review part 1901 via a web browser 101, the system undergoes the aforementioned analysis process. The system will analyze the data from the submission with the Fraud Detection Module 107 and inform the Authentication Module 106 if it has detected a medium risk of Fraud Activity part 1703. The medium risk of fraud activity is generated when any of the algorithms part 2301, 2302, 2303, 2304, 2305 and 2306 triggers a fraud alert. Note that the algorithm parameters may be selected according to a variety of criteria depending on the characteristics of the ratable object, characteristics of the authentication/verification standard, expected level of risk and/or any other criteria.

For example, algorithm 2301 determines whether a rater/reviewer submits a negative review. The first algorithm 2301 works as follows: If the rater/reviewer submits a negative review which is a rating 201 of 1 or 2, the rater/review will go through the additional vetting process 805 which is exemplified in FIG. 9, FIG. 10, FIG. 11, FIG. 12, FIG. 13, FIG. 14, FIG. 15 and FIG. 16.

Algorithm 2302 determines whether to flag the reviews as suspect on the basis of whether the reviews are collected in ad hoc and free formed manner and not with some of the automated tools that the system provides—e.g. email requests for reviews sent out to the organization's customer base. The second algorithm 2302 works as follows: If the ratable object receives a rating/review without using any of the system's proactive tools to solicit reviews, then the system will redirect the rater/review to go through the additional vetting process 805 which is exemplified in FIG. 9, FIG. 10, FIG. 11, FIG. 12, FIG. 13, FIG. 14, FIG. 15 and FIG. 16.

The proactive tools used in 2302 are the system's email solicitation, images, web pages and/or pop-ups. Email solicitation allows the owner of the ratable object to request reviews via email to the rater/reviewer to actually rate/review the ratable object. The Site Seal or embedded web page or pop-up is an image, page or pop-up that is placed next to the ratable object to create a call to action for the user to rate/review the ratable object. The system is able to count the number of times the image, pages and/or pop-ups are delivered and if the image has not been delivered a sufficient number of times as predefined in the system before a review is placed, then the system will redirect the rater/review to go through the additional vetting process 805 which is exemplified in FIG. 9, FIG. 10, FIG. 11, FIG. 12, FIG. 13, FIG. 14, FIG. 15 and FIG. 16.

The algorithms provide a variety of triggers to alert the system to medium fraud risk. Algorithm 2303 determines whether the rater/reviewer creates and submits a review in under a pre-determined amount of time and/or whether the time period to write a review is greater than a pre-defined word per minute rate. The third algorithm 2303 works as follows: If the rater/reviewer submits a rating/review in less than X milliseconds, where X is a variable that is defined and configured in the system, the rater/review will go through the additional vetting process 805 which is exemplified in FIG. 9, FIG. 10, FIG. 11, FIG. 12, FIG. 13, FIG. 14, FIG. 15 and FIG. 16. One of skill in the art will easily implement algorithm 2303, 2304, 2305 and 2306 without further detail.

Algorithm 2304 determines whether the rater/reviewer has submitted a review that is too long or too short. The forth algorithm 2304 works as follows: If the rater/reviewer's submission is either to long or short as pre-defined in the system, then the rater/review will go through the additional vetting process 805 which is exemplified in FIG. 9, FIG. 10, FIG. 11, FIG. 12, FIG. 13, FIG. 14, FIG. 15 and FIG. 16.

The fifth algorithm 2305 works as follows: If the rater/reviewer submits a review were the read (reviews read)/write (reviews written) ratio of the ratable object is less than X as pre-defined in the system, then the rater/reviewer will go through the additional vetting process 805 which is exemplified in FIG. 9, FIG. 10, FIG. 11, FIG. 12, FIG. 13, FIG. 14, FIG. 15 and FIG. 16.

The sixth algorithm 2306 works as follows: If the ratable object has less than X number of reviews as pre-defined by system, the rater/reviewer will go through the additional vetting process 805 which is exemplified in FIG. 9, FIG. 10, FIG. 11, FIG. 12, FIG. 13, FIG. 14, FIG. 15 and FIG. 16.

FIG. 24 illustrates a screen shot of the system variables that may be configured and function as described in FIG. 22 and FIG. 23. The details as to how these systems work are described above and variations can easily be envisioned by one of skill in the art. The first configurable variable part 2401 allows the system to set a time period in hours to detect fraud activity if an IP address of a rater/review for a ratable object matches the IP address collected from the ratable object owner 2201. If the time frame is less than the variable presented in part 2401, then rater/reviewer will go through the additional vetting process 805 which is exemplified in FIG. 9, FIG. 10, FIG. 11, FIG. 12, FIG. 13, FIG. 14, FIG. 15 and FIG. 16.

The second configurable variable part 2402 allows the system to detect potential fraud if the configurable variable X (the first number of positive reviews that warrant additional authentication) 2402 that are collected from a rater/reviewer. If the review is submitting a positive review and the number of positive reviews including this new positive review is less than the configurable variable part 2402, then the rater/reviewer will go through the additional vetting process 805 which is exemplified in FIG. 9, FIG. 10, FIG. 11, FIG. 12, FIG. 13, FIG. 14, FIG. 15 and FIG. 16.

The third configurable variable part 2403, if a rater/reviewer fails to have their site seal rendered more than X times before a reviewer submits a positive rating/review and the system's email solicitation service has not been to used to request a review for the ratable object, then the rater/reviewer will go through the additional vetting process 805 which is exemplified in FIG. 9, FIG. 10, FIG. 11, FIG. 12, FIG. 13, FIG. 14, FIG. 15 and FIG. 16.

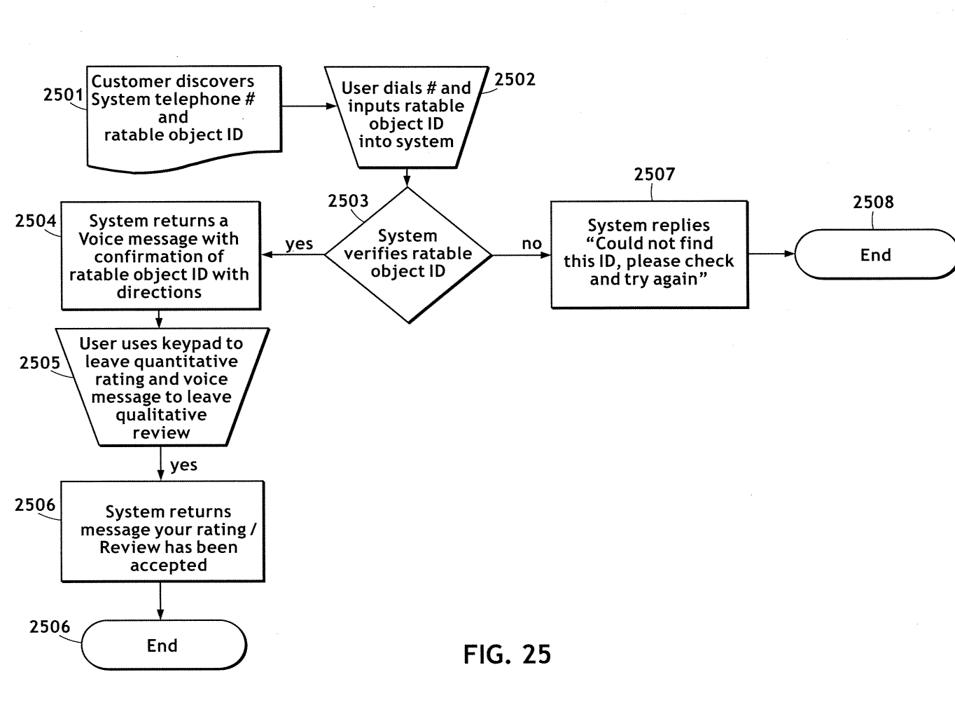

FIG. 25 illustrates a block diagram showing an exemplary system to submit a Telephony 102 user rating/review for a Ratable Object via the submission portal & protocols 1001 of the system. To submit a rating/review, a rater/reviewer will need to have a voice telephone with touch-tone enable device. Once the rater/reviewer is notified of the ability to rate/review a ratable object with a telephone enabled device and provided the two key variables to rate/review the ratable object which are: 1. The ratable objects unique number ID and 2. The phone number part 2501 in which to submit the review for the ratable object. A user will dial the phone number and wait for the indicator to insert the ratable object ID part 2502. The system will verify that the unique code exists part 2503 and if so will return a voice message to the user that the ratable object ID was found and provide direction on how to submit a rating/review comment part 2504. If the system could not find the ratable object ID 2503 then the system will return a voice response that states the system could not find the ratable object ID part 2507 and end the process part 2608. If the ratable object ID was found in 2503 and returns the direction to complete the process part 2504, the rater/reviewer may leave a rating similar to 201 with their telephone keypad enable device, the optionally leave a voice review to complete the submission for the ratable object. Once the rater/reviewer confirms that the rating/review is complete by selecting a # key on their telephone keypad, then the system will return a message that rating/review has been accepted part 2506 and the process will end part 2506.

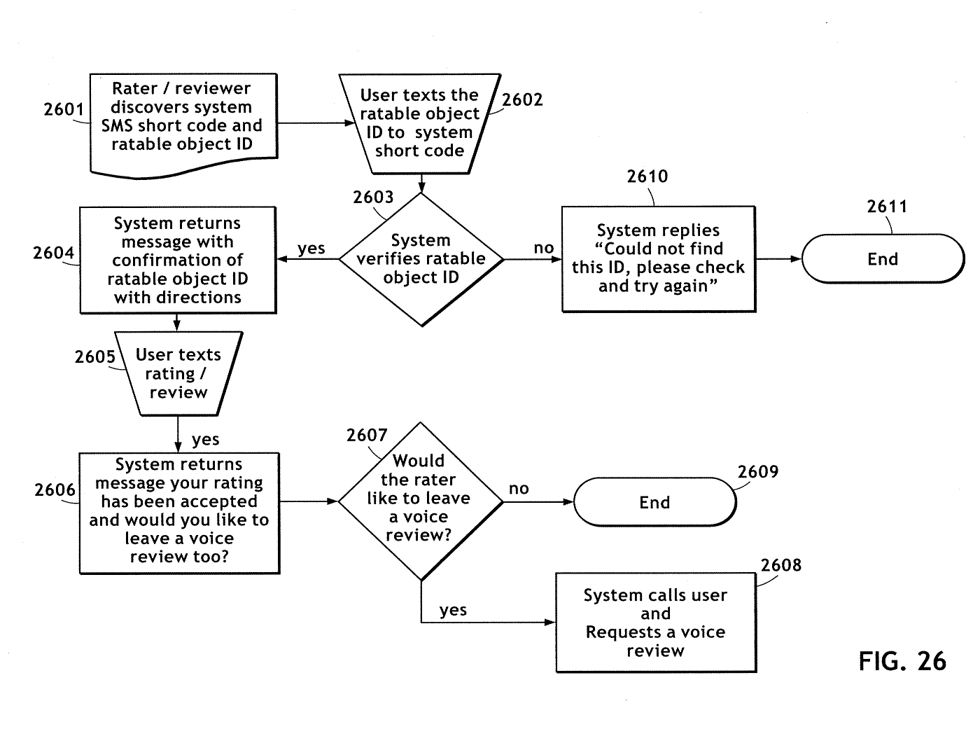

FIG. 26 illustrates a block diagram showing an exemplary system to submit a SMS (Short Message Service) 103 user rating/review for a Ratable Object via the submission portal & protocols 1001 of the system. To submit a rating/review, a rater/reviewer will need to have a SMS based device like a cell phone or similar communication means. Once the rater/reviewer is notified of the ability to rate/review a ratable object with an SMS enabled device and provided the two key variables to rate/review the ratable object which are: 1. The ratable objects unique number ID and 2. The phone number or Short Code (a 5 or 6 digit number that may replace a phone number for SMS messages) part 2601 in which to submit the review for the ratable object. A user will send or text the ratable object ID to the phone number or Short Code part 2602. The system will verify that the unique code exists part 2603 and if so will return a message to the user that the ratable object ID was found and provide direction on how to submit a textual comment part 2604. If the system could not find the ratable object ID 2603 then the system will return a response that states the system could not find the ratable object ID part 2610 and end the process part 2611. If the ratable object ID was found in 2603 and returns the direction to complete the process part 2604, the rater/reviewer may submit a textual comment part 2605, the system will return another textual response that indicates that the review has been accepted and would the rater/reviewer like to leave a voice review as well part 2606. If the user selects that they would like to leave a voice review by selecting 1 in their reply SMS message part 2607, then the system will call the user on the rater/reviewers device SMS enabled mobile phone number being used and ask them to leave a voice review at the sound 2608. If the reviewer selects 2 or does not respond then the process will end part 2609.

FIG. 27 illustrates a block diagram showing the exemplary architecture of the system, where the system router, firewall and load balancing part 2701 are in multiple clusters that then provide access to the Application Cluster part 2702 that contains rater/reviewer submission portal and protocols 1001 and rating/review processing application 1002. The third section holds to the database cluster part 2703 that is also displayed in 108. For example, database cluster part 2703 may retain data relevant to the ratable object, the rater/reviewer usage history, IP addresses, relevant time frames and processing parameters. The Application Cluster 2702 handles all the processing of the systems and methods described above. The Site Seal/Tools/Review Content Delivery Servers part 2701 handle the delivery of rating and review for the ratable objects, but do not actually collect 1001 or process 1002 the reviews. Each of the process flows represented in the above-described figures (e.g. FIG. 4, FIG. 8, FIG. 17, FIG. 19, FIG. 21, FIG. 25, FIG. 26) are intended to be enacted by the apparatus 2701, 2702, 2703, and 2704 or other suitable components. That is, the process flows, abstractly represented, are electronically enacted via the implementation of algorithms by the computer server system.

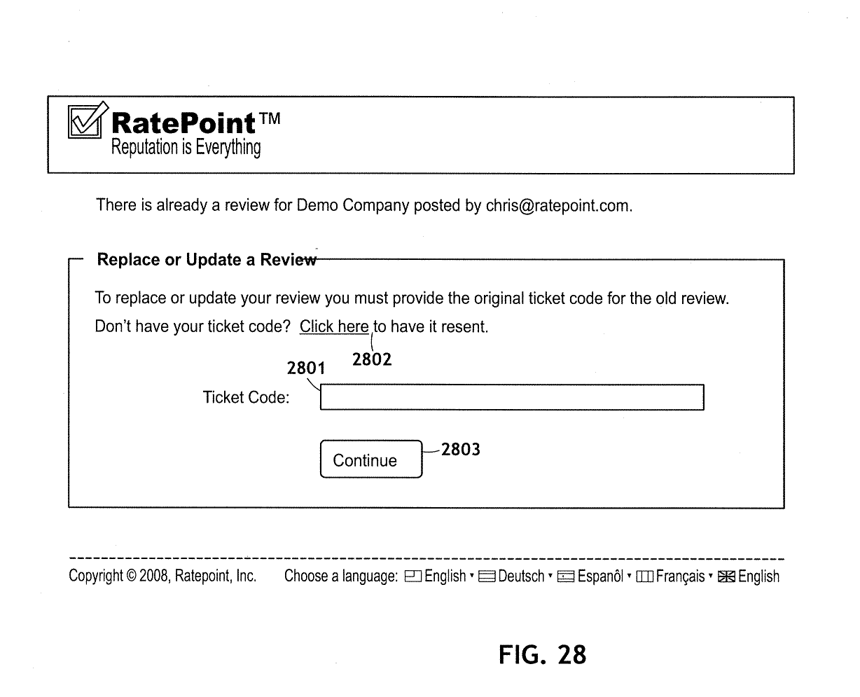

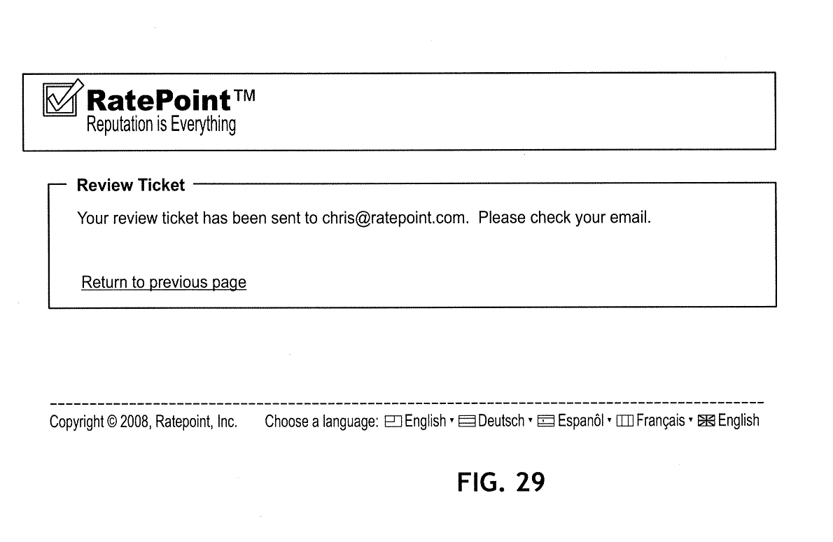

FIG. 28 illustrates an exemplary embodiment of a duplicate rating/review submission display using an http Web Browser 102. Once the rater/reviewer submits the review 207 and the Email 202 is the same as a previous email submitted for the same ratable object, the duplicate rating/review submission display of FIG. 28 inform the rater/review that a previous review exists from the rater/reviews email address. The rater/reviewer, at this point, may abandon process or may insert a ticket code part 2801 that would have been received via email after the original review was submitted. If the user does not have access to the ticket code then they can have it sent to them at the same email address again part 2802. Once the user has the ticket code, and submits the code part 2803 then the “Review Ticket” display depicted in FIG. 29 will appear.

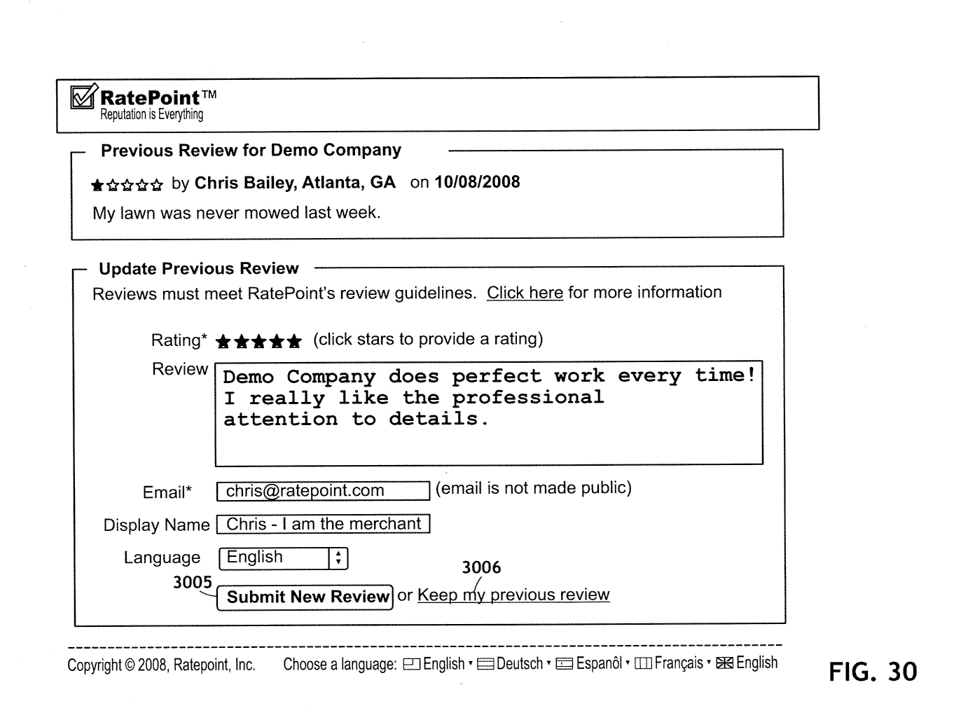

FIG. 29 illustrates an example “Review Ticket” display the rater/reviewer will receive upon submission of the code part 2803 above. The “Review Ticket” display informs the rater/review to check the email to confirm the review. Once the user verifies the email as described above with reference to FIG. 12, then FIG. 30 will display.

FIG. 30 illustrates an example “Update Previous Review” display the rater/reviewer will receive when attempting to update a submission. The display informs the user that they are about to make a change to the previous rating/review. The user may Submit the rating/review to overwrite the previous review part 3005. Alternately, the user can do nothing (automatically preserving the previous rating/review) or choose to keep the previous rating/review part 3006.

### Alternate Embodiments

The systems and methods as described above may be applied to other services and protocols 104 not mentioned in this document. The interface to system's rating and review services is accessible via the system API that allows a developer to create a custom interface into the system environment over other standard or proprietary protocols to collect, process and store ratings and reviews for ratable objects.

For example, a developer could enable a live public or private chat service to solicit reviews for a ratable object at the end of a chat session. The service could verify the user's Chat ID with the chat provider and/or perform an out of band authentication process with a phone, SMS, and/or email verification based on the information requested from and provided by the Chat Session users. Thus a plurality of protocols to collect, process, and store ratings and reviews for ratable objects are envisioned.

As noted above, the system can be expanded to rate many different types of objects. Specific examples of ratable objects on which the rating system can be used include products (electronics, books, music, movies), services (web services, utility services), people, virtual people, organizations, websites, web pages, any other object that can be associated with an unique ID. Furthermore, once a unique ID is assigned to a ratable object, the ID can be accepted via multiple protocols as mentioned above, http web brower, email, voice phone and SMS. The protocols can be expanded to include Instant messaging like AOL, Yahoo, MSN, etc or proprietary services like corporate Live Chat products and services like LivePerson, Boldchat, ActivaLive and others. The system can even blend the protocols by accepting the review via one protocol and delivering the confirmation results to another protocol. The rating/and reviews may be quantitative (e.g. 5 stars) or qualitative ratings (e.g. free formed textual, video, voice, other types of media comments). Additionally, the rating UI or scale can be modified, for example the system could except any UI other than a star rating and accept something other than a 5-unit scale. For example, the system can easily accept a 2-unit, 10-unit, 100-unit, or any other quantitative or qualitative scale.

In each case the system fraud algorithms could be applied and expanded to ensure that the rating and reviews that are received form the rater/review are bonafide such that other users of the ratings/reviews can trust that the information presented in the review does not conceal or misrepresent the information about the ratable object. Furthermore, the system's fraud algorithms could be modified and optimized for a particular type of ratable object. For example, a business rating/review might require the authentication/vetting methods described above, but a product review might require a modified set of authentication/vetting methods to ensure a rating/review is bonafide. In a business review the system asks the user to present their email address and potentially telephone number. In a product review, the system might require proof of purchase via: 1. a serial number, 2. an invoice number that can be matched to the product vendor's transaction database, 3. a verification with the issuing bank for a credit card, check or other payment method that would match the payment details to the issuing bank or like organization, and/or 4. a match with the shipping identification number/tracking ID.

The system's current algorithms can optionally be enhanced by applying Cookies to all users and tracking behaviors overtime to determine potential fraud activity. This includes instances in which a rater/reviewer may be: 1. rating certain organizations negatively, 2. flooding the system with reviews inappropriately, and/or 3. discovering a relationship with competitive ratable objects as determined by category or textual analysis.

Furthermore, the system can apply a Cookie via some scripting to a user's browser on the first web page displayed for a successfully completed transaction. This Cookie will identify that the user did, in fact, conduct a transaction with the organization. This information can be used to proactively solicit a user to review the organization upon the user's return to the site. Soliciting a return user for a review can be implemented via, for example, a pop-up review request. As noted above, the information can be used to prove that the user had a transaction with the organization. In yet other embodiments, the system applies a Cookie to a transaction confirmation page to rate a product and collect the unique product ID that was purchased via an API. Later, the system can solicit a pop-up review request if that visitor returns to the organization's website. A Transaction ID and/or Product Unique ID can be used to prove that the rater had a transaction relationship with the ratable object.

While the above description refers to specific embodiments of a system and method for determining bonafide reviews ratable objects, other embodiments are possible. For example the system's fraud detection measures may be used to stop other types of fraudulent activity. For example: the system's fraud detection measures are flexible and could be used to vet an organization or person before they signup with another system, service or organization to receive certain products, services or access to read, add or modify information

Additionally, other methods of fraud detection can be identified as more patterns of fraudulent transactions appear. This could include, the system automatically monitoring usage activity of the system rater/reviewer and analyze and compare that information to produce a profile that describes in computerized form the usage of the rater/reviewer. Those profiles are subsequently analyzed to compare usage among other raters/reviewer. The usage analysis profile of the user includes web-visiting records, rating records, etc. and may be categorize as the Review Source of the Ratable Object 3001 to determine fraud activity. While the above discussion has explicitly identified target objects such as a company, a product, a URI, a web site, web page content, a virtual object, virtual products, or virtual service (e.g. virtual objects, product and services are found inside a gaming environment and other virtual worlds), any range of ratable objects could be rated with the system.

The system can adjust the application of the vetting and authentication procedures for various ratable objects. For example, the system can ask for an invoice number for a review corresponding to the rater/reviewer's transaction with a business. Or, the system can ask for a transaction ID that might be used to prove that a reviewer purchased a certain product before they review that product.

Another process flow that may be implemented includes one reflecting a more detailed understanding of the relationship of the rater/review to the system. In this embodiment, the computerized system may evaluate whether the rater/reviewer is known or unknown to the system, how long has the rater/reviewer been a registered (or unregistered) rater on the system, where the rater/reviewer is geographically located in their rating profile as compared to the current geographic location of their IP address, phone number or SMS number, etc. By creating a computerize model of known fraudulent activity behaviors of the system's raters/reviews locating the more correlative data variable that the system stores for these users, the system can develop a regression model to better determine future fraud activity from raters/reviewer. Additionally, the system could use a measure of relationship and/or closeness to detect otherwise-difficult to find fraud. For various methods and systems for determining relationship and closeness measures see U.S. patent application Ser. No. 11/639,678. For example: the aforementioned computer implemented algorithms could detect someone negatively reviewing hair salons, which may indicate competitive fraud activity. An alternate indication is that a group of businesses are rating each other to drive up positive reviews on their partner businesses artificially, without their businesses being otherwise identified as fraudulent.

The present invention, in its various embodiments, utilizes a range of computer and computer system technologies widely known in the art, including memory storage technologies, central processing units, input/output methods, bus control circuitry and other portions of computer architecture. Additionally, a broad range of Internet technologies well-known in the art are used.

The system described above is an open system in which bonafide ratings are generated from rating sources across a wide variety of platforms. Instead of applying a vetting process to ratings submitted through a single user platform, transaction service, or website, the present system and method are flexible enough to evaluate ratings submitted through a plurality of platforms. For example, when the method is used to legitimate a rating submitted by a rater who is rating a ratable object on a first platform (e.g. a seller on Amazon.com who is selling category A of products), the system will check whether the user has an activity history on a second platform (e.g. the rater is selling category A of products on e-Bay). (In this example, if the rater submits a negative rating, that rating may be flagged as medium or high risk of being biased or fraudulent rating). Thus the vetting process is not limited to transactions and activity history on a single platform and instead, reaches across multiple platforms to enact a broad vetting process for an arbitrary ratable object in a wide area electronic network.

Moreover, the system described above generates bonafide ratings from a multi-dimensional evaluation process. Whereas authentication and verification systems may perform a single-dimensional check, the present system and method legitimate ratings by contextualizing a particular rating with respect to other variables. The system contextualizes the rating by: (1) analyzing information about the ratable object, (2) analyzing information about the rater/reviewer who is submitting the rating and (3) analyzing details about the content and submission process of the rating itself, etc. For the purpose of illustration, a rating for a business could be vetted by examining, for example: (1) the sort of business being rated—what does it sell? what is its geographic location? (2) who is rating the business—does he/she sell similar products? is he/she located in a similar geographic region? does he/she have a history of submitting negative ratings? did he/she sign up for a rating profile? (3) is the rating negative/positive? is the rating submitted within X hours of the alleged transaction with the business? Moreover, the system may evaluate a rater's connectedness to a transaction based on a range of inferences, enacted through the computer implemented algorithms. As illustrated by the aforementioned example, the bonafide ratings are generated through a multi-dimensional vetting process that incorporates a wide variety of variables about the rating/review, the ratable object and the rater/reviewer. It is through this multi-dimensional vetting process that the method and system ensures, with various clear, quantified measures, that the ratings are legitimate and trustworthy. In other words, the multi-dimensional process is designed to identify multiple way bias could manifest.

The system described above generates bonafide ratings from a multi-step vetting process. Instead of only identifying a fraud risk and allowing or rejecting the rating, the present method involves an iterative process. An initial evaluation of risk level (see threat matrix detailed in FIG. 3) may trigger subsequent risk evaluation steps. For example, an initial medium risk evaluation outcome may cause the system to take steps to scrutinize the rating further, placing a telephone call or sending an email for confirmation. In yet other instances, the system may undergo a first set of algorithms (see FIG. 23) and, depending on the outcome of that first set of algorithms, place a telephone call or send an email confirmation and, subsequent to confirmation, enact a second set of algorithms (see FIG. 23). The system and method are flexible enough to adjust the multi-step vetting process to accommodate numerous applications, security levels and even user preferences. The overall result is that the system generates bonafide ratings that a user can depend on as trustworthy to a clear and quantifiable legitimacy level.

Thus the flexibility of the present system and method rely on the cross-platform nature, the multi-dimensional analysis, and the iterative vetting process. The system overcomes the need for a pre-authenticated user by implementing a variety of techniques to observe usage history and make plausible inferences about the user's biases or vested interests. Because the system is not limited to using fixed criteria, it can generate trustworthy ratings for arbitrary ratable objects in a wide area electronic network.

It will be further appreciated that the scope of the present invention is not limited to the above-described embodiments but rather is defined by the appended claims, and that these claims will encompass modifications and improvements to what has been described.

What is claimed is:

1. A method, performed on a computer system, providing a computer-based service to automatically evaluate and determine authenticity of a rating, the method comprising:
(a) receiving input at the computer system with rating information, the rating information including a rating for a specified ratable object and identification data for the ratable object;
(b) receiving input at the computer system with rater profile information, the rater profile information including at least one of identification information and usage information associated with an active user of the computer based service;
(c) performing at least one evaluation step, the at least one evaluation step evaluating the received input at the computer system, wherein evaluating comprises determining a risk level associated with the rating information, the rater profile information, and a time frame associated with receiving input;
(d) determining, based on the risk level, an evaluation outcome message;
(e) communicating to the active user the evaluation outcome message, the evaluation outcome message including at least one of an acceptance message, an information request message, and a rejection message;
wherein upon communication of the acceptance message, the computer-based service accepts the rating for the specified ratable object for storage in a rating information database, wherein upon communication of the information request message, the computer-based service implements a verification process, and wherein upon communication of the rejection message, the computer-based service rejects the rating for the specified ratable object for storage in the rating information database.

2. The method of claim 1 wherein the ratable object comprises one of a business, a person, a product, a URI, a website, web page content, a virtual object, a virtual product, or a virtual service.

3. The method of claim 1 wherein receiving input at the computer system comprises receiving electronic information by way of one of a URI, an Internet capable application, Javascript, SMS texting, Telephone, Flash object, and application program interface (API).

4. The method of claim 1 wherein communicating to the active user an evaluation outcome message includes transmitting electronic information by way of one of a URI, an Internet capable application, Javascript, SMS texting, Telephone, Flash object, and application program interface (API).

5. The method of claim 1 wherein the evaluation step comprises classifying the rating as one of positive and negative.

6. The method of claim 1 wherein the evaluation step comprises evaluating the rater profile information to determine whether the active user is an ad hoc user.

7. The method of claim 1 wherein the evaluation step comprises evaluating the rater profile information to determine whether the active user is a recruited user.

8. The method of claim 1 wherein the evaluation step comprises evaluating usage information to determine a usage history via at least one of tracking an IP address, applying a cookie and requesting usage information from the active user.

9. The method of claim 1 wherein evaluating a time frame associated with receiving input comprises determining whether an upper or lower time limit for receiving input at the computer system with rating information is exceeded.

10. The method of claim 1 wherein evaluating the rating information comprises determining whether an upper or lower text limit for rating information is exceeded.

11. The method of claim 1 wherein determining a risk level comprises identifying a combination of rating information, the rater profile information, and time frame associated with receiving input as high risk.

12. The method of claim 1 wherein determining a risk level comprises identifying a combination of rating information, the rater profile information, and time frame associated with receiving input as medium risk.

13. The method of claim 1 wherein determining a risk level comprises identifying a combination of rating information, the rater profile information, and time frame associated with receiving input as low risk.

14. The method of claim 1 wherein the verification process comprises automatically communicating to the active user via at least one of an SMS message, an e-mail message, a telephone call, a facsimile and a postal message, a request for additional information.

15. The method of claim 14, wherein the request for additional information includes one of active user confirmation, additional identification information and additional usage information associated with the active user.

16. The method of claim 1, wherein upon communication of the acceptance message, the method further comprises assigning a transaction identity to the rating information, the transaction identity comprising the risk level, the evaluation outcome message, the rater profile information, and the time frame associated with receiving input.

17. The method of claim 1, wherein upon communication of the rejection message, the method further comprises assigning a transaction identity to the rejected rating information, the transaction identity comprising the risk level, the evaluation outcome message, the rater profile information, and the time frame associated with receiving the input.
